(19) United States
(12) Patent Application Publication
(10) Pub. No.: US 2026/0273927 A1
(43) Pub. Date: Sep. 17, 2026

(54) LIQUID EJECTING HEAD AND LIQUID EJECTING APPARATUS

(71) Applicant: SEIKO EPSON CORPORATION, Tokyo (JP)

(72) Inventors: Kento NAWA, SHIOJIRI-SHI (JP); Ken YAMAGISHI, SHIOJIRI-SHI (JP)

(21) Appl. No.: 19/567,734

(22) Filed: Mar. 16, 2026

(30) Foreign Application Priority Data
Mar. 17, 2025 (JP) 2025-042140

(51) Int. Cl. B41J 2/045; B41J 2/14

(52) U.S. Cl. CPC B41J 2/0451; B41J 2/04541; B41J 2/04581; B41J 2/14233; B41J 2002/14491

(57) ABSTRACT

A liquid ejecting head includes: a piezoelectric substrate having a plurality of piezoelectric elements; a wiring substrate; and a flexible substrate that electrically couples the piezoelectric substrate and the wiring substrate, in which the flexible substrate includes a plurality of drive signal wirings that are arranged in a direction along a Y-axis and transmit drive signals, an analog signal wiring, and a constant voltage wiring held at a potential different from a potential of an analog signal transmitted through the analog signal wiring, the wiring substrate includes a detection circuit that outputs a detection signal based on the analog signal, and the analog signal wiring and the constant voltage wiring are adjacent to each other and are disposed outside the plurality of drive signal wirings in the direction along the Y-axis.

The present application is based on, and claims priority from JP Application Serial Number 2025-042140, filed Mar. 17, 2025, the disclosure of which is hereby incorporated by reference herein in its entirety.

### BACKGROUND

### 1. Technical Field

The present disclosure relates to a liquid ejecting head and a liquid ejecting apparatus.

### 2. Related Art

Liquid ejecting apparatuses are known that print images by ejecting a liquid such as ink from a plurality of nozzles using piezoelectric elements. For example, a liquid ejecting apparatus has a liquid ejecting head including a plurality of drive elements for ejecting a liquid. For example, JP-A-2016-88084 discloses a liquid ejecting head provided with a flexible cable having a plurality of individual coupling wirings and a common coupling wiring for driving a plurality of piezoelectric elements. Hereinafter, the flexible cable may also be referred to as a flexible substrate.

When migration occurs due to moisture adhering to the flexible substrate or due to the flexible substrate being exposed to a high humidity environment, or when the flexible substrate is exposed to outgassing containing sulfur, there is a concern that the individual coupling wirings for driving the respective drive elements may be coupled to each other and cause a short circuit. Therefore, it is desirable to predict the life of the flexible substrate before an ejection failure occurs due to such a short circuit.

### SUMMARY

According to an aspect of the present disclosure, there is provided a liquid ejecting head including: an actuator substrate having a plurality of drive elements for ejecting a liquid; a wiring substrate; and a flexible substrate that electrically couples the actuator substrate and the wiring substrate, in which the flexible substrate includes a plurality of individual wirings that are arranged in a first direction and transmit a drive signal for driving each of the plurality of drive elements, a first analog signal wiring that transmits an analog signal, and a first wiring held at a first potential different from a potential of the analog signal transmitted through the first analog signal wiring, the wiring substrate includes a detection circuit that outputs a detection signal for detecting a state of the actuator substrate based on the analog signal transmitted via the first analog signal wiring, and the first analog signal wiring is adjacent to the first wiring and is disposed outside the plurality of individual wirings in the first direction.

According to another aspect of the present disclosure, there is provided a liquid ejecting apparatus including: a liquid ejecting head including an actuator substrate having a plurality of drive elements for ejecting a liquid, a wiring substrate, and a flexible substrate that electrically couples the actuator substrate and the wiring substrate; and a detection circuit, in which the flexible substrate includes a plurality of individual wirings that are arranged in a first direction and transmit a drive signal for driving each of the plurality of drive elements, a first analog signal wiring that transmits an analog signal, and a first wiring held at a first potential different from a potential of the analog signal transmitted through the first analog signal wiring, the detection circuit outputs a detection signal for detecting a state of the actuator substrate based on the analog signal transmitted via the first analog signal wiring, and the first analog signal wiring is adjacent to the first wiring and is disposed outside the plurality of individual wirings in the first direction.

### BRIEF DESCRIPTION OF THE DRAWINGS

FIG. 1 is a schematic diagram illustrating a configuration of a liquid ejecting apparatus according to a first embodiment.

FIG. 2 is a diagram showing a functional configuration of the liquid ejecting apparatus shown in FIG. 1.

FIG. 3 is an exploded perspective view of a liquid ejecting head shown in FIG. 2.

FIG. 4 is an explanatory view for describing a schematic structure of a liquid ejecting module shown in FIG. 3.

FIG. 5 is a cross-sectional view showing a piezoelectric substrate of FIG. 4.

FIG. 6 is a plan view showing the piezoelectric substrate of FIG. 4.

FIG. 7 is a view showing a flexible substrate shown in FIG. 4.

FIG. 8 is a view showing an example of a detection circuit shown in FIG. 2.

FIG. 9 is a view showing a flexible substrate according to a first modification example.

FIG. 10 is a view showing a flexible substrate according to a second modification example.

### DESCRIPTION OF EMBODIMENTS

Embodiments for carrying out the present disclosure will be described below with reference to the drawings. Meanwhile, in each drawing, the dimensions and scale of each portion are different from the actual dimensions and scale as appropriate. In addition, the embodiments described below are preferred specific examples of the present disclosure, and therefore, various technically preferable limitations are given, but the scope of the present disclosure is not limited to these forms unless there is a description to the effect that the present disclosure is particularly limited in the following description.

### 1. First Embodiment

### 1-1. Overall Configuration of Liquid Ejecting Apparatus 100

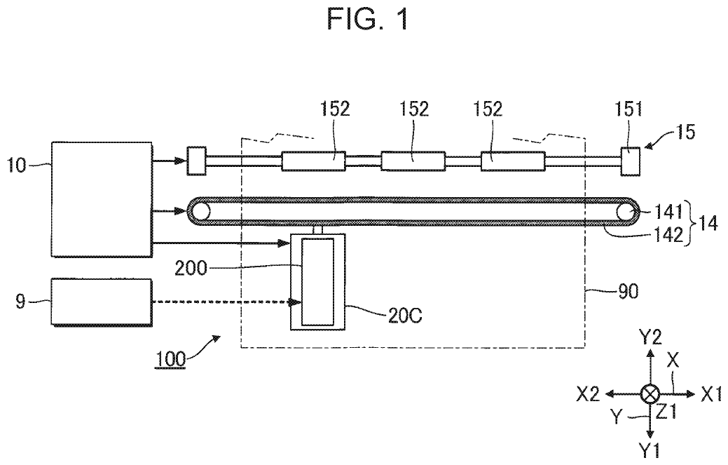

FIG. 1 is a schematic diagram illustrating a configuration of a liquid ejecting apparatus 100 according to a first embodiment. For convenience of description, the following description will be made using an X-axis, a Y-axis, and a Z-axis, which are orthogonal to each other as appropriate. In the following description, one direction along the X-axis is referred to as an X1 direction, and the direction opposite to the X1 direction is referred to as an X2 direction. Similarly, one direction along the Y-axis is referred to as a Y1 direction, and the direction opposite to the Y1 direction is referred to as a Y2 direction. One direction along the Z-axis is referred to as a Z1 direction, and the direction opposite to the Z1 direction is referred to as a Z2 direction. Also, viewing in a direction along the Z-axis may be referred to as “in a plan view”. The Z-axis is typically a vertical axis. The Z2 direction is an upward direction, and the Z1 direction is a downward direction. Hereinafter, a +Z direction may be referred to as the upward or upward direction, and a −Z direction may be referred to as the downward or downward direction. Note that, the Z-axis may not be the vertical axis. The X-axis, the Y-axis, and the Z-axis are typically orthogonal to each other, but are not limited thereto, and only need to intersect each other at, for example, an angle within a range of, for example, 80° or more and 100° or less.

The liquid ejecting apparatus 100 in FIG. 1 is an ink jet printing apparatus that ejects a liquid such as ink onto a medium 90. As shown in FIG. 1, in the present embodiment, it is assumed as an example that the liquid ejecting apparatus 100 is a so-called serial printer. The medium 90 is typically printing paper, but any printing target made of a resin film, fabric, or other material is used as the medium 90.

A liquid container 9 for storing a liquid is installed on the liquid ejecting apparatus 100. For example, a cartridge that can be attached to and detached from the liquid ejecting apparatus 100, a bag-shaped liquid pack made of a flexible film, or a liquid tank that can be replenished with a liquid is used as the liquid container 9.

The liquid ejecting apparatus 100 includes a control unit 10, a medium transport mechanism 15, a moving mechanism 14, and a liquid ejecting head 200.

The control unit 10 includes, for example, one or more processing circuits such as a central processing unit (CPU) or a field programmable gate array (FPGA) and one or more storage circuits such as a semiconductor memory, and comprehensively controls each element of the liquid ejecting apparatus 100.

The medium transport mechanism 15 transports the medium 90 in a direction along the Y-axis under the control of the control unit 10. For example, the medium transport mechanism 15 includes a transport motor 151 and a plurality of transport rollers 152. The transport motor 151 operates under the control of the control unit 10. The plurality of transport rollers 152 rotate in accordance with an operation of the transport motor 151. As the plurality of transport rollers 152 rotate, the medium 90 is transported in a direction along the Y-axis, which is a transport direction.

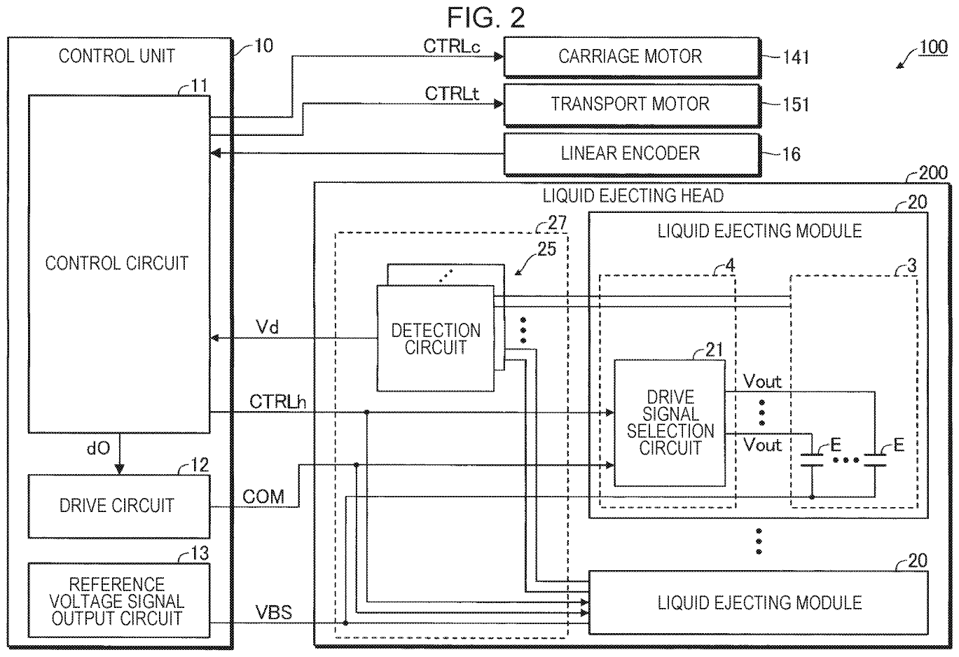

The moving mechanism 14 reciprocates a carriage 20C on which the liquid ejecting head 200 is mounted along the X-axis under the control of the control unit 10. For example, the moving mechanism 14 includes a carriage motor 141 and an endless belt 142. The carriage motor 141 operates under the control of the control unit 10. The endless belt 142 rotates in accordance with an operation of the carriage motor 141. This causes the carriage 20C fixed to the endless belt 142 to reciprocate along the X-axis, which is a scanning axis. Also, a linear encoder 16 shown in FIG. 2, which will be described later, is attached to the moving mechanism 14 in order to output a position detection signal based on the position of the carriage 20C.

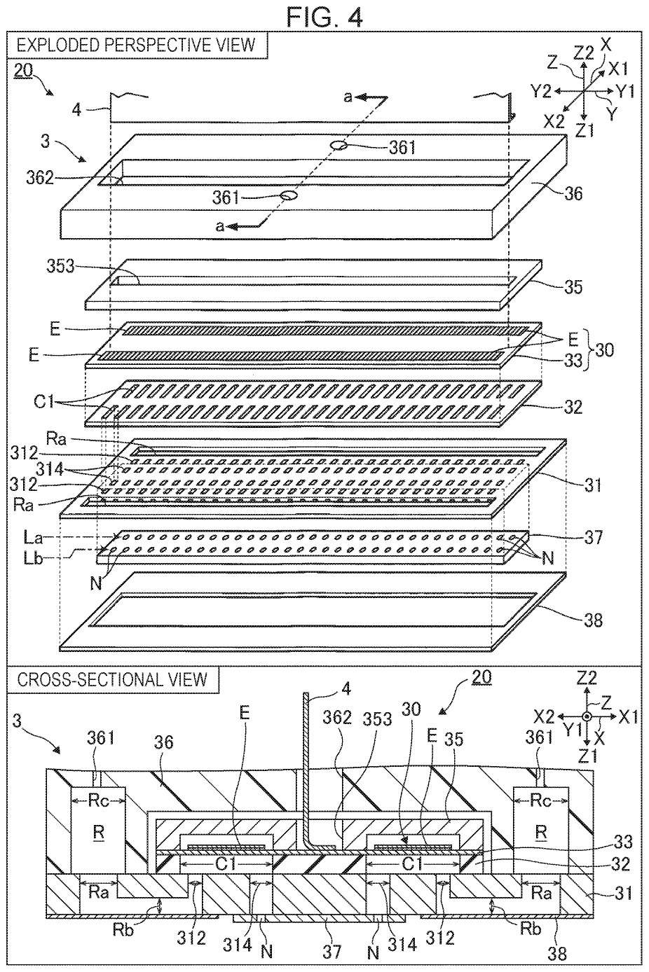

The liquid ejecting head 200 ejects the liquid supplied from the liquid container 9 onto the medium 90 from a plurality of nozzles N shown in FIG. 4, which will be described later, under the control of the control unit 10. An image is formed at the surface of the medium 90 by each liquid ejecting head 200 ejecting a liquid onto the medium 90 in parallel with the transport of the medium 90 by the medium transport mechanism 15 and the reciprocating movement of the carriage 20C by the moving mechanism 14.

In FIG. 1, it is assumed that the liquid ejecting apparatus 100 is a serial printer, and therefore a serial head method in which the liquid ejecting head 200 reciprocates above the medium 90 is employed as the printing method. However, the printing method of the liquid ejecting apparatus 100 may be a line head method in which the liquid ejecting head 200 is fixed. That is, the liquid ejecting apparatus 100 may be a so-called line printer.

FIG. 2 is a diagram showing the functional configuration of the liquid ejecting apparatus 100 shown in FIG. 1.

The control unit 10 includes a control circuit 11, a drive circuit 12, and a reference voltage signal output circuit 13. The control circuit 11 receives an image information signal including image data or the like from an external device such as a host computer that is coupled to the outside of the liquid ejecting apparatus 100 in a communicable manner. The control circuit 11 generates various signals for controlling the liquid ejecting apparatus 100 based on the image information signal, and outputs the various signals to the corresponding components.

In addition to the image information signal, the control circuit 11 receives a position detection signal from the linear encoder 16 based on a scanning position of the carriage 20C. The control circuit 11 ascertains the scanning position of the liquid ejecting head 200 mounted on the carriage 20C based on the position detection signal. The control circuit 11 generates a control signal CTRLc for controlling the movement of the liquid ejecting head 200 in accordance with the scanning position of the liquid ejecting head 200, and outputs the generated control signal CTRLc to the carriage motor 141. The control circuit 11 also generates a control signal CTRLt for controlling the transport of the medium 90, and outputs the generated control signal CTRLt to the transport motor 151.

The control circuit 11 generates a control signal CTRLh for controlling the liquid ejecting head 200 based on the above-described image information signal and the scanning position of the liquid ejecting head 200, and outputs the generated control signal CTRLh. The control signal CTRLh includes, for example, a print signal, a latch signal, a clock signal, and the like for designating the type of operation of the liquid ejecting head 200.

Furthermore, the control circuit 11 receives a detection signal Vd from the liquid ejecting head 200 to detect physical information such as the temperature, the humidity, and the pressure of the liquid ejecting head 200. For example, the control circuit 11 corrects the control signals CTRLh, CTRLc, and CTRLt based on the detection signal Vd. Further, the control circuit 11 may stop the operation of the liquid ejecting apparatus 100 based on the detection signal Vd.

The control circuit 11 outputs a base drive signal dO, which is a digital signal, to the drive circuit 12. The drive circuit 12 converts the base drive signal dO into an analog signal, amplifies the analog signal, and generates a drive signal COM, and outputs the generated drive signal COM to the liquid ejecting head 200.

The reference voltage signal output circuit 13 generates a reference voltage signal VBS and outputs the generated signal to the liquid ejecting head 200. The reference voltage signal VBS is a constant potential signal that serves as a reference for driving a piezoelectric element E (to be described later) of the liquid ejecting head 200. For example, the reference voltage signal VBS is a DC voltage signal with a constant potential. The potential of the reference voltage signal VBS is an example of a “first potential”.

The liquid ejecting head 200 has a plurality of liquid ejecting modules 20 and a plurality of detection circuits 25 corresponding to the plurality of liquid ejecting modules 20. Note that the plurality of liquid ejecting modules 20 all have the same configuration. Further, the plurality of detection circuits 25 all have the same configuration. The plurality of detection circuits 25 are mounted on, for example, a wiring substrate 27.

Each liquid ejecting module 20 includes, for example, a drive signal selection circuit 21 mounted on the flexible substrate 4 and a plurality of piezoelectric elements E included in the head chip 3. The control signal CTRLh, the drive signal COM, and the reference voltage signal VBS output from the control unit 10 are input to each liquid ejecting module 20 via the wiring substrate 27. Specifically, the control signal CTRLh and the drive signal COM are input to the drive signal selection circuit 21. The drive signal selection circuit 21 generates the drive signal Vout for each piezoelectric element E by selecting or not selecting the signal waveform of the drive signal COM based on the control signal CTRLh. The drive signal selection circuit 21 inputs each drive signal Vout to one end of the corresponding piezoelectric element E individually. Further, the reference voltage signal VBS is commonly input to the other end of each of the plurality of piezoelectric elements E. Each of the plurality of piezoelectric elements E is driven by a potential difference between the supplied drive signal Vout and the reference voltage signal VBS. Then, the amount of liquid corresponding to the driving of each of the plurality of piezoelectric elements E is ejected. The plurality of piezoelectric elements E are an example of a “plurality of drive elements”.

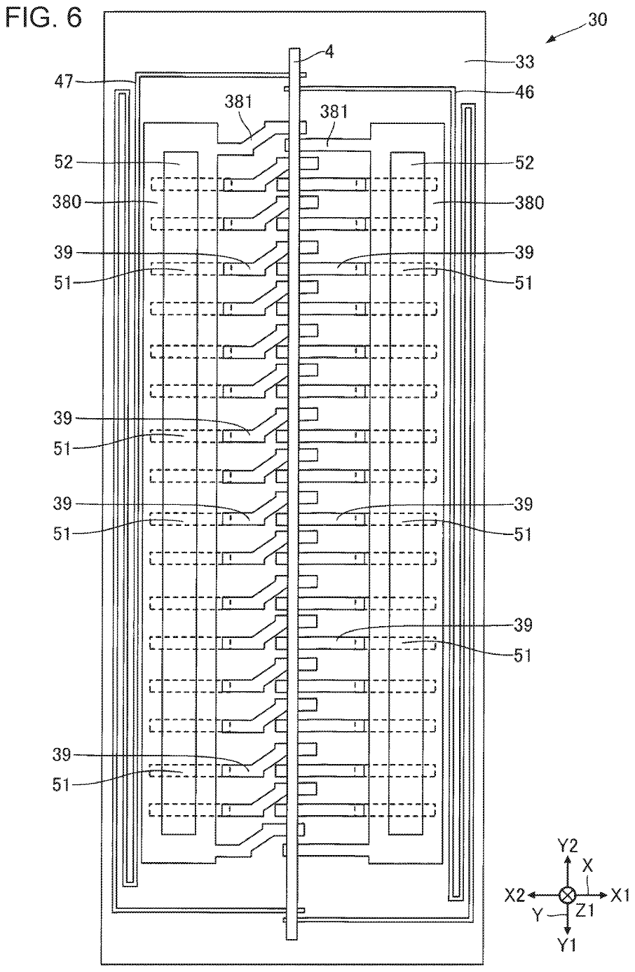

The detection circuit 25 receives, from each of the plurality of liquid ejecting modules 20, analog signals corresponding to physical information such as the temperature, the humidity, and the pressure of each of the liquid ejecting modules 20. In the present embodiment, a case where the physical information is the temperature of the liquid ejecting module 20 is assumed. For example, the detection circuit 25 is electrically coupled to a first resistance wiring 46 and a second resistance wiring 47 of the head chip 3 shown in FIG. 6, which will be described later, via the flexible substrate 4. Then, the detection circuit 25 generates a detection signal Vd based on an analog signal corresponding to the potential difference between the first resistance wiring 46 and the second resistance wiring 47, and outputs the generated detection signal Vd to the control unit 10.

### 1-2. Liquid Ejecting Head 200

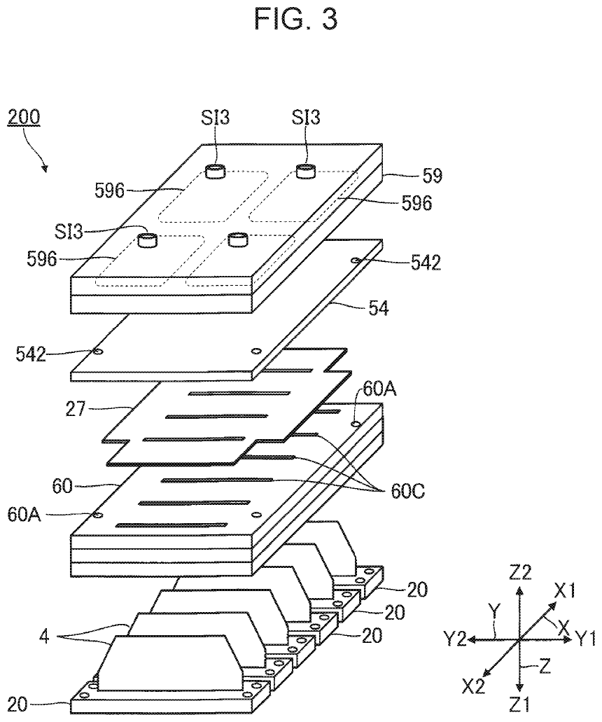

FIG. 3 is an exploded perspective view of the liquid ejecting head 200 shown in FIG. 2. The liquid ejecting head 200 shown in FIG. 3 includes a filter portion 59, a communication member 54, a wiring substrate 27, a liquid distribution portion 60, and a plurality of liquid ejecting modules 20. The filter portion 59, the communication member 54, the wiring substrate 27, the liquid distribution portion 60, and the plurality of liquid ejecting modules 20 are arranged in this order in the Z1 direction.

In the shown example, the plurality of liquid ejecting modules 20 are six liquid ejecting modules 20. The plurality of liquid ejecting modules 20 are arranged in a direction along the X-axis at intervals from each other. Each liquid ejecting module 20 includes the flexible substrate 4.

The filter portion 59 is an element that removes air bubbles and foreign matter contained in the liquid supplied from the liquid container 9. The filter portion 59 is a flat plate made of a resin material. Furthermore, for example, the filter portion 59 is provided with four filters 596 according to the type of liquid.

Furthermore, the filter portion 59 is provided with four supply ports SI3 for supplying the liquid from the liquid container 9 to the filter portion 59.

The communication member 54 is a flat plate made of an elastic material. The communication member 54 is formed with a plurality of through holes 542 through which a liquid from the filter portion 59 flows.

The wiring substrate 27 is a substrate on which wiring is formed for transmitting various signals such as the drive signal COM and power supply voltage to each liquid ejecting module 20. The wiring substrate 27 is provided in common to the plurality of liquid ejecting modules 20. The wiring substrate 27 has, for example, the detection circuit 25 shown in FIG. 2 mounted thereon. Furthermore, the wiring substrate 27 is formed with coupling terminals (not shown) to which the flexible substrates 4 of the respective liquid ejecting modules 20 are electrically coupled, and the wiring substrate 27 and the flexible substrates 4 are electrically coupled.

The liquid distribution portion 60 is a member that distributes the liquid supplied via each through hole 542 of the communication member 54 to each liquid ejecting module 20. The liquid distribution portion 60 is composed of a stack of a plurality of flat plate members. The liquid distribution portion 60 is made of a resin material. The liquid distribution portion 60 is also provided with a through hole 60C through which the flexible substrate 4 is inserted.

The liquid ejecting head 200 in FIG. 3 is an example, and any element may be further added to the liquid ejecting head 200 or may be omitted. For example, the liquid distribution portion 60 and a holder may be integrally configured. Furthermore, the disposition relationship of the elements of the liquid ejecting head 200 is not limited to the example shown in FIG. 3. For example, the wiring substrate 27 may be located to the side of the plurality of liquid ejecting modules 20.

### 1-3. Liquid Ejecting Module 20

FIG. 4 is an explanatory view for describing the schematic structure of the liquid ejecting module 20 shown in FIG. 3. The upper diagram in FIG. 4 is an exploded perspective view of the liquid ejecting module 20, and the lower diagram in FIG. 4 is a cross-sectional view taken along line a-a shown in the exploded perspective view. The a-a cross section is parallel to the XZ plane and passes through a supply port 361, which will be described later. The liquid ejecting module 20 includes a head chip 3 and a flexible substrate 4. The Z-axis is an axis along the direction in which the liquid is ejected by the liquid ejecting head 200.

As illustrated in the exploded perspective view of FIG. 4, the head chip 3 of the liquid ejecting module 20 has a plurality of nozzles N arranged along the Y-axis. The plurality of nozzles N are divided into a first nozzle row La and a second nozzle row Lb that are arranged in parallel at intervals along the X-axis. The second nozzle row Lb is arranged in parallel in a direction along the first nozzle row La. Each of the first nozzle row La and the second nozzle row Lb is a set of a plurality of nozzles N arranged linearly along the Y-axis. The liquid ejecting module 20 has a structure in which elements related to each nozzle N of the first nozzle row La and elements related to each nozzle N of the second nozzle row Lb are disposed in a substantially plane-symmetrical manner. In the following, the elements corresponding to the first nozzle row La will be mainly described, and the description of the elements corresponding to the second nozzle row Lb will be omitted as appropriate.

As illustrated in FIG. 4, the head chip 3 has a flow path forming substrate 31, a pressure chamber substrate 32, a vibration plate 33, a nozzle substrate 37, a vibration absorbing body 38, a plurality of piezoelectric elements E, a sealing body 35, and a flow path housing portion 36. Each of the flow path forming substrate 31, the pressure chamber substrate 32, the vibration plate 33, the nozzle substrate 37, the vibration absorbing body 38, the sealing body 35, and the flow path housing portion 36 is an elongated plate-shaped member along the Y-axis. Also, the nozzle substrate 37, the flow path forming substrate 31, the pressure chamber substrate 32, the vibration plate 33, and the sealing body 35 are arranged in this order in the Z2 direction. In addition, the vibration plate 33 and the plurality of piezoelectric elements E constitute a piezoelectric substrate 30. The piezoelectric substrate 30 is an example of an “actuator substrate”.

The nozzle substrate 37 is a plate-shaped member in which the plurality of nozzles N are formed. The nozzle substrate 37 includes the first nozzle row La and the second nozzle row Lb. Each of the plurality of nozzles N is a circular through hole that ejects a liquid. The nozzle substrate 37 is bonded to the surface of the flow path forming substrate 31 in the Z1 direction with, for example, an adhesive.

The flow path forming substrate 31 forms a flow path through which the liquid flows. Specifically, the flow path forming substrate 31 is formed with a space Ra, a relay liquid chamber Rb, a plurality of supply flow paths 312, and a plurality of communication flow paths 314. The space Ra is an opening formed in an elongated shape along the Y-axis. Each of the supply flow path 312 and the communication flow path 314 is a through hole formed for each of nozzles N. Each communication flow path 314 overlaps with a corresponding nozzle N in a plan view seen from the Z1 direction. The relay liquid chamber Rb is a space formed in an elongated shape along the Y-axis across the plurality of nozzles N, and communicates the space Ra and the plurality of supply flow paths 312 with each other. Furthermore, the pressure chamber substrate 32 is bonded to the Z2 direction surface of the flow path forming substrate 31 with an adhesive.

The pressure chamber substrate 32 is coupled to the piezoelectric substrate 30. The pressure chamber substrate 32 is provided with a pressure chamber C1 whose volume changes with deformation of the piezoelectric substrate 30. The pressure chamber substrate 32 can also be considered to partition the pressure chambers C1. The pressure chamber substrate 32 is made of silicon oxide. The liquid to be ejected from the nozzle N is stored in the pressure chamber C1. The pressure chamber C1 is a space located between the nozzle substrate 37 and the vibration plate 33 and formed by the inner wall surface of the pressure chamber substrate 32. The pressure chamber C1 is formed for each of nozzles N. The pressure chamber C1 is an elongated space extending in the X1 direction. The plurality of pressure chambers C1 are arranged along the Y-axis. Each pressure chamber C1 communicates with the communication flow path 314 and the supply flow path 312. Accordingly, the pressure chamber C1 communicates with the nozzle N via the communication flow path 314, and also communicates with the space Ra via the supply flow path 312 and the relay liquid chamber Rb.

The nozzle substrate 37, the flow path forming substrate 31, and the pressure chamber substrate 32 are manufactured by processing a silicon (Si) single crystal substrate using semiconductor manufacturing techniques such as photolithography and etching, for example. However, any well-known materials and methods can be employed for manufacturing the nozzle substrate 37, the flow path forming substrate 31, and the pressure chamber substrate 32.

The vibration plate 33 of the piezoelectric substrate 30 is coupled to the surface of the pressure chamber substrate 32 opposite to the flow path forming substrate 31. The vibration plate 33 is disposed above the pressure chamber C1 and is elastically deformable.

The vibration plate 33 vibrates by driving the piezoelectric element E. The vibration plate 33 is a plate-shaped member formed in a long rectangular shape along the Y-axis in a plan view. The vibration plate 33 and the pressure chamber C1 may be integrally formed, or may be formed as separate bodies and bonded with an adhesive or the like.

The piezoelectric element E is formed at the surface of the vibration plate 33 opposite to the pressure chamber C1. The piezoelectric element E is provided for each of pressure chambers C1. The piezoelectric element E is formed in an elongated shape along the X-axis in a plan view.

The piezoelectric element E is a drive element that is driven by application of the drive signal Vout, and applies a pressure to the liquid in the pressure chamber C1.

The sealing body 35 is bonded to the vibration plate 33 with, for example, an adhesive. The sealing body 35 is a structure that protects the plurality of piezoelectric elements E and reinforces a mechanical strength of the pressure chamber substrate 32 and the vibration plate 33. The sealing body 35 has a recess formed at the surface facing the vibration plate 33. A plurality of piezoelectric elements E are accommodated inside the recess. Also, the sealing body 35 has a space 353 through which the flexible substrate 4 is inserted.

Furthermore, the vibration absorbing body 38 is bonded to the surface of the flow path forming substrate 31 in the Z1 direction with, for example, an adhesive. The vibration absorbing body 38 is a flexible film that forms the wall surface of the space Ra.

The flow path housing portion 36 is bonded to the flow path forming substrate 31 with, for example, an adhesive. The flow path housing portion 36 is a case for storing the liquid to be supplied to the plurality of pressure chambers C1. The flow path housing portion 36 is formed by injection molding of a resin material, for example. In the flow path housing portion 36, a space Rc, a supply port 361, and a space 362 are formed. The supply port 361 is a pipeline through which the liquid is supplied from the liquid container 9 via the liquid distribution portion 60, and communicates with the space Rc. The space Rc communicates with the space Ra of the flow path forming substrate 31. The space formed by the space Rc and the space Ra functions as a liquid storage chamber R that stores the liquid to be supplied to the plurality of pressure chambers C1. The liquid supplied from the liquid container 9 and passed through the supply port 361 is stored in the liquid storage chamber R. The liquid stored in the liquid storage chamber R is branched from the relay liquid chamber Rb to each supply flow path 312 and is supplied in parallel to the plurality of pressure chambers C1. Further, the space 362 overlaps with the space 353 of the sealing body 35 in a plan view. The flexible substrate 4 is inserted through the space 353 and the space 362.

The flexible substrate 4 is coupled to the vibration plate 33. The flexible substrate 4 electrically couples the piezoelectric substrate 30 and the wiring substrate 27 to each other. The flexible substrate 4 is a mount component on which the plurality of wirings are formed. For example, the flexible substrate 4 is a flexible printed circuit (FPC) or a chip on film (COF), which is a flexible circuit substrate. The flexible substrate 4 is mounted with the drive signal selection circuit 21 shown in FIG. 2.

In the liquid ejecting module 20 shown in FIG. 4, when the piezoelectric element E is flexibly deformed by application of a voltage, the vibration plate 33 is flexibly deformed in a direction that reduces the volume of the pressure chamber C1. That is, when the piezoelectric element E is flexibly deformed by application of a voltage, the vibration plate 33 vibrates. As a result, the pressure in the pressure chamber C1 changes, and the liquid in the pressure chamber C1 is ejected from the nozzles N. After the liquid is ejected, the piezoelectric element E is restored to its original position.

The configuration of the liquid ejecting module 20 is not limited to the example shown in FIG. 4. For example, the liquid ejecting module 20 may not have some of the plurality of elements shown in FIG. 4, or may have other elements instead of some of the plurality of elements shown in FIG. 4. Alternatively, the liquid ejecting module 20 may have other elements in addition to the plurality of elements shown in FIG. 4.

### 1-4. Piezoelectric Substrate 30

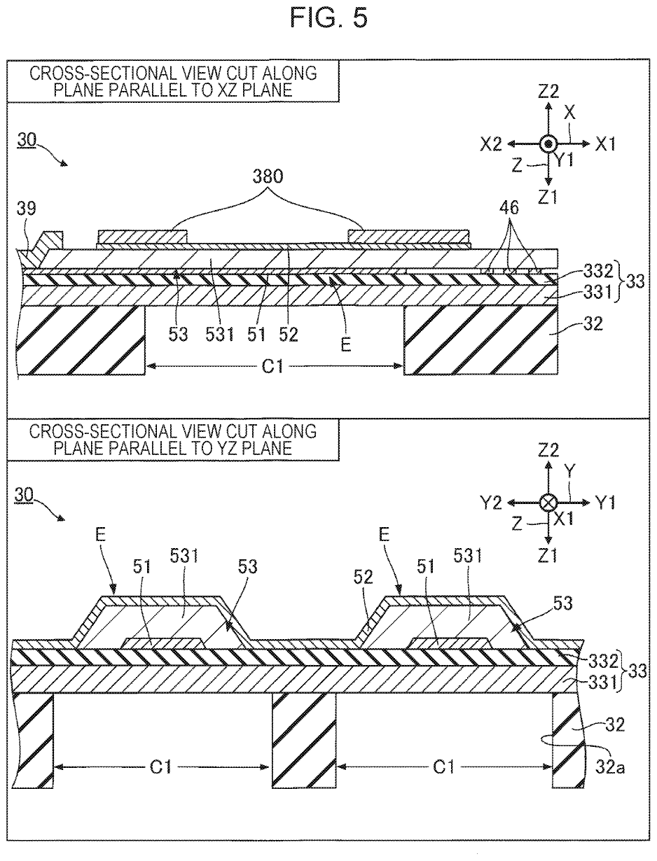

FIG. 5 is a cross-sectional view showing the piezoelectric substrate 30 of FIG. 4. FIG. 6 is a plan view showing the piezoelectric substrate 30 of FIG. 4.

The upper diagram in FIG. 5 is a cross-sectional view of the piezoelectric substrate 30 when the piezoelectric substrate 30 is cut along a plane parallel to the XZ plane to include the piezoelectric element E. The lower diagram in FIG. 5 is a cross-sectional view of the piezoelectric substrate 30 when the piezoelectric substrate 30 is cut along a plane parallel to the YZ plane to include the piezoelectric element E. In FIG. 5, the pressure chamber substrate 32 is also shown in order to facilitate understanding of the piezoelectric substrate 30.

As shown in FIG. 5, the vibration plate 33 of the piezoelectric substrate 30 is formed of a stack including, for example, a first layer 331 and a second layer 332. The first layer 331 is in contact with the pressure chamber substrate 32. The second layer 332 is disposed above the first layer 331. The second layer 332 is located at a position closer to the piezoelectric element E than the first layer 331. The second layer 332 is formed of an insulating material such as zirconium oxide (ZrOx). The first layer 331 is formed by, for example, thermally oxidizing a portion of the pressure chamber substrate 32. The second layer 332 is formed by a well-known film formation technique such as sputtering. The vibration plate 33 may be made up of one layer or three or more layers.

The piezoelectric element E mainly has individual electrodes 51, a piezoelectric layer 53, and a common electrode 52. The individual electrodes 51, the piezoelectric layer 53, and the common electrode 52 are stacked in a direction along the Z-axis, which is a stacking direction.

In addition, the piezoelectric layer 53 has a plurality of piezoelectric portions 531. Note that the piezoelectric layer 53 is not shown in FIG. 6.

The individual electrodes 51 are provided above the vibration plate 33. The individual electrodes 51 are individual electrodes provided for each piezoelectric element E. The drive signal Vout is applied to the individual electrode 51. The individual electrodes 51 are formed in an elongated shape along the X-axis. The plurality of individual electrodes 51 are arranged at intervals along the Y-axis. The individual electrodes 51 include a conductive material such as metal.

The piezoelectric layer 53 is provided above the individual electrodes 51. The piezoelectric layer 53 is, for example, a band-shaped dielectric film that extends continuously along the Y-axis across the plurality of piezoelectric elements E. The piezoelectric layer 53 has, for example, a band shape extending along the Y-axis, and is separated into individual piezoelectric elements E by forming a plurality of notches. By forming the plurality of notches, the piezoelectric layer 53 has the plurality of piezoelectric portions 531. The plurality of individual electrodes 51 described above are provided in correspondence with the plurality of piezoelectric portions 531. The piezoelectric layer 53 is made of a piezoelectric material having a perovskite crystal structure, for example.

Examples of the piezoelectric material include lead titanate (PbTiO₃), lead zirconate titanate (PZT:Pb(Zr, Ti)O₃), lead zirconate (PbZrO₃), lead lanthanum titanate ((Pb, La), TiO₃), lead lanthanum titanate zirconate ((Pb, La) (Zr, Ti)O₃), lead zirconate niobate titanate (Pb(Zr, Ti, Nb)O₃), and lead magnesium niobate zirconate titanate (Pb(Zr, Ti)(Mg, Nb)O₃). Among them, lead zirconate titanate (PZT) is preferably used as the constituent material of the piezoelectric layer 53.

The common electrode 52 is provided above the piezoelectric layer 53. The common electrode 52 is a band-shaped common electrode that extends continuously along the Y-axis across the plurality of piezoelectric elements E. The common electrode 52 is commonly provided to the plurality of piezoelectric portions 531 described above. The reference voltage signal VBS is applied to the common electrode 52. The common electrode 52 includes a conductive material such as a metal.

A voltage corresponding to a difference between the reference voltage signal VBS applied to the common electrode 52 and the drive signal Vout corresponding to the ejection amount supplied to the individual electrode 51 is applied to the piezoelectric portion 531. When a voltage is applied between the individual electrode 51 and the common electrode 52, the piezoelectric portion 531 is deformed, and the piezoelectric element E is flexibly deformed, that is, vibrates by the deformation of the piezoelectric portion 531.

In addition, a weight portion 380 is provided above the common electrode 52 in contact with the common electrode 52.

As shown in FIG. 6, the weight portion 380 has a rectangular frame shape. The weight portion 380 functions as a weight for suppressing excessive vibration of the vibration plate 33. Furthermore, a coupling electrode 381 is coupled to the weight portion 380. The coupling electrode 381 is coupled to the flexible substrate 4. The reference voltage signal VBS is applied to the common electrode 52 described above via the coupling electrode 381 and the weight portion 380. Note that the weight portion 380 includes a metal such as gold.

As shown in FIGS. 5 and 6, a coupling electrode 39 is coupled to each of the individual electrodes 51 described above. The coupling electrode 39 is coupled to the flexible substrate 4. The drive signal Vout is applied to the above-described individual electrode 51 via the coupling electrode 39. Note that the coupling electrode 39 includes a metal such as gold.

In an example shown in FIG. 5, the individual electrode 51 is provided below the piezoelectric layer 53, and the common electrode 52 is provided above the piezoelectric layer 53. However, the common electrode 52 may be provided below the piezoelectric layer 53 and the individual electrode 51 may be provided above the piezoelectric layer 53.

As shown in FIG. 6, the first resistance wiring 46 and the second resistance wiring 47 are provided on the surface of the piezoelectric substrate 30 facing the Z2 direction. The first resistance wiring 46 is provided along the first nozzle row La in a plan view. The second resistance wiring 47 is provided along the second nozzle row Lb in a plan view. Therefore, a resistance value of the first resistance wiring 46 is likely to change in response to temperature changes in the plurality of pressure chambers C1 corresponding to the first nozzle row La. A resistance value of the second resistance wiring 47 is likely to change in response to temperature changes in the plurality of pressure chambers C1 corresponding to the second nozzle row Lb.

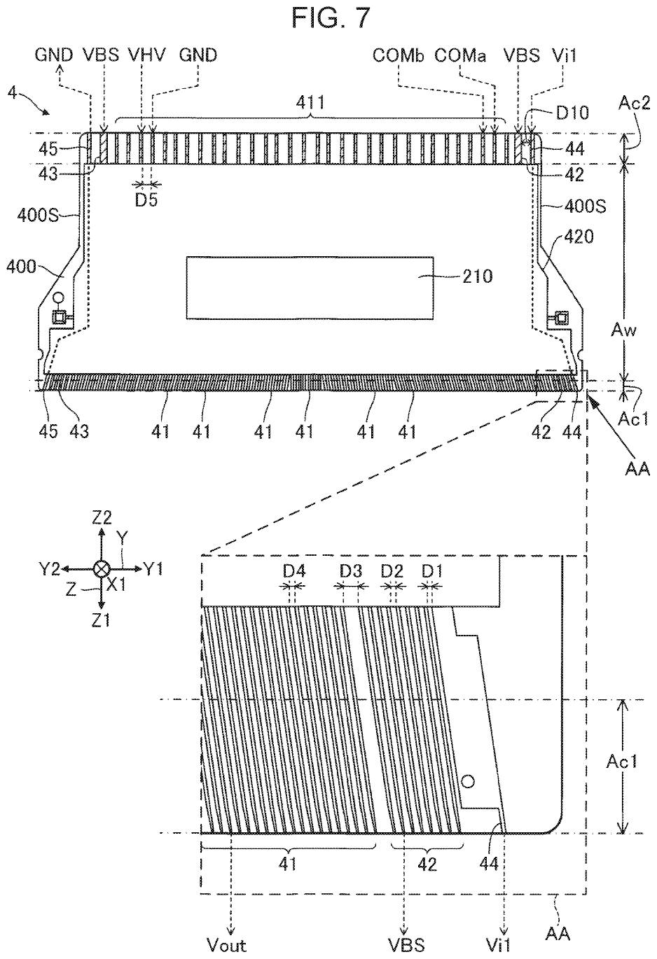

In the present embodiment, one end of the first resistance wiring 46 and one end of the second resistance wiring 47 are coupled to a first analog signal wiring 44 of the flexible substrate 4 shown in FIG. 7, which will be described later. The other end of the first resistance wiring 46 and the other end of the second resistance wiring 47 are coupled to a second analog signal wiring 45 of the flexible substrate 4 shown in FIG. 7, which will be described later. Therefore, the first resistance wiring 46 and the second resistance wiring 47 are coupled in parallel.

The first resistance wiring 46 and the second resistance wiring 47 are coupled in parallel, which makes it possible to achieve a lower resistance than when the first resistance wiring 46 and the second resistance wiring 47 are coupled in series. Furthermore, since the first resistance wiring 46 is provided along the first nozzle row La and the second resistance wiring 47 is provided along the second nozzle row Lb, average information on the first nozzle row La and the second nozzle row Lb can be acquired.

Each of the first resistance wiring 46 and the second resistance wiring 47 is disposed in a bellows shape to reciprocate a plurality of times along the Y-axis. Therefore, since the wiring lengths of the first resistance wiring 46 and the second resistance wiring 47 are increased, the resistance of the first resistance wiring 46 and the second resistance wiring 47 can be increased.

The disposition of the first resistance wiring 46 and the second resistance wiring 47 is not limited to the example shown in FIG. 6. For example, each of the first resistance wiring 46 and the second resistance wiring 47 may be disposed without reciprocating a plurality of times along the Y-axis. Furthermore, the first resistance wiring 46 may be configured to be arranged in a portion of the first nozzle row La, and the second resistance wiring 47 may be configured to be arranged in a portion of the second nozzle row Lb. Also, in addition to the first resistance wiring 46 and the second resistance wiring 47, a different resistance wiring may be provided.

### 1-5. Flexible Substrate 4

FIG. 7 is a view showing the flexible substrate 4 shown in FIG. 4. FIG. 7 also shows an enlarged view of an area AA enclosed by a broken line.

The length of the flexible substrate 4 along the Y-axis is, for example, substantially equal to the length from one end to the other end of the first nozzle row La. Furthermore, for example, the flexible substrate 4 has a first coupling area Ac1 that is coupled to the piezoelectric substrate 30 at the end portion in the Z1 direction. The flexible substrate 4 also has a second coupling area Ac2 that is coupled to the wiring substrate 27 at the end portion in the Z2 direction. The flexible substrate 4 has a wiring area Aw between the first coupling area Ac1 and the second coupling area Ac2. As shown in the cross-sectional view of FIG. 4, the flexible substrate 4 is bent at substantially 90 degrees at the boundary portion between the first coupling area Ac1 and the wiring area Aw. Note that FIG. 7 shows the flexible substrate 4 in a state of not being bent.

As described above, the first coupling area Ac1 is a portion that is coupled to the piezoelectric substrate 30, and is a portion that is bent relative to the wiring area Aw and spreads in the X-Y plane. The wiring area Aw is a portion that is not directly coupled to the piezoelectric substrate 30. The wiring area Aw is a portion that spreads in the Y-Z plane and extends from the piezoelectric substrate 30 in the Z2 direction. A mount component 210 is provided in the wiring area Aw. The mount component 210 is mounted with, for example, the drive signal selection circuit 21 shown in FIG. 2. In addition, most of the wiring area Aw is covered with an insulating cover film 420 made of resin such as polyimide. In FIG. 7, the first analog signal wiring 44 and the second analog signal wiring 45 in the portion covered with the cover film 420 are indicated by dotted lines. In FIG. 7, among the various wirings in the portion covered with the cover film 420, those other than the first analog signal wiring 44 and the second analog signal wiring 45 are omitted from the illustration to avoid complicating understanding.

For example, the flexible substrate 4 has a base material 400, a plurality of wirings 411, a plurality of drive signal wirings 41, a plurality of first constant voltage wirings 42, a plurality of second constant voltage wirings 43, a first analog signal wiring 44, a second analog signal wiring 45, and a mount component 210. The flexible substrate 4 does not necessarily have to include the mount component 210. In this case, the drive signal selection circuit 21 is provided on the wiring substrate 27 coupled to the second coupling area Ac2 of the flexible substrate 4 or on a separate substrate. When the flexible substrate 4 does not have the drive signal selection circuit 21, for example, one end and the other end of each of the plurality of drive signal wirings 41 are disposed in the first coupling area Ac1 and the second coupling area Ac2, respectively.

The base material 400 is an insulating material made of resin such as polyimide. The base material 400 is a flexible film-like member. On the base material 400, a plurality of drive signal wirings 41, a plurality of first constant voltage wirings 42, a plurality of second constant voltage wirings 43, a first analog signal wiring 44, and a second analog signal wiring 45 are formed. As described above, these wirings are covered with the cover film 420 in most of the wiring area Aw. The directions in which the plurality of drive signal wirings 41, the plurality of first constant voltage wirings 42, the plurality of second constant voltage wirings 43, the first analog signal wirings 44, and the second analog signal wirings 45 are arranged are substantially the same, that is, substantially along the Z-axis. As described in FIG. 6, the first analog signal wiring 44 and the second analog signal wiring 45 are electrically coupled by the first resistance wiring 46 and the second resistance wiring 47.

The plurality of wirings 411 are located in the Z2 direction relative to the plurality of drive signal wirings 41. The plurality of wirings 411 are located, for example, at the center portion of the base material 400 in the Y-axis. The plurality of wirings 411 are arranged along the Y-axis at intervals from each other. The plurality of wirings 411 are input wirings for inputting input signals such as a drive signal COM, a latch signal, and a clock signal to the mount component 210, and are coupled to the wiring substrate 27 and the mount component 210. In an example shown in FIG. 7, the plurality of wirings 411 include wirings to which the drive signals COMa and COMb are respectively supplied as the drive signal COM. The plurality of wirings 411 may also include wirings used as power supply voltages for the mount component 210 and various components of the liquid ejecting module 20. The plurality of wirings 411 include two wirings to which a high potential VHV and a ground potential GND are respectively supplied, for example. The high potential VHV is, for example, the highest potential supplied to the liquid ejecting module 20. In the example shown in FIG. 7, two wirings to which a high potential VHV and a ground potential GND are respectively supplied are adjacent to each other. Therefore, when attention is paid to the potential difference between adjacent wirings, two wirings to which the high potential VHV and the ground potential GND are respectively supplied are wirings in which migration is likely to occur. In the present embodiment, a case where the potential difference between the high potential VHV and the ground potential GND is about 42 V is assumed. In the following description, unless otherwise specified, the numerical example of a potential of interest means the potential difference of the potential of interest with respect to the ground potential GND.

The plurality of drive signal wirings 41 are located in the Z1 direction on the base material 400 and are provided at the center portion of the base material 400 in the Y-axis. The plurality of drive signal wirings 41 are arranged along the Y-axis at intervals from each other. The direction along the Y-axis corresponds to a “first direction”. The plurality of drive signal wirings 41 are an example of a “plurality of individual wirings”. The plurality of drive signal wirings 41 are output wirings that transmit drive signals Vout to the plurality of piezoelectric elements E, and are coupled to the mount component 210 and the piezoelectric substrate 30. The plurality of drive signal wirings 41 correspond in a one-to-one manner to the plurality of individual electrodes 51.

The first constant voltage wiring 42 and the second constant voltage wiring 43 are located outside the plurality of drive signal wirings 41 on the base material 400 in the Y-axis, and are disposed to interpose the group of the plurality of drive signal wirings 41 in the Y-axis. The first constant voltage wiring 42 and the second constant voltage wiring 43 are disposed to interpose the group of a plurality of wirings 411 in the Y-axis direction. The first constant voltage wiring 42 and the second constant voltage wiring 43 are not coupled to the mount component 210, and are arranged from the second coupling area Ac2 on the input side located in the Z2 direction of the flexible substrate 4 to the first coupling area Ac1 on the output side located in the Z1 direction. That is, one end and the other end of each of the first constant voltage wiring 42 and the second constant voltage wiring 43 are disposed respectively in the first coupling area Ac1 and the second coupling area Ac2. Each of the first constant voltage wiring 42 and the second constant voltage wiring 43 is a single wiring in the second coupling area Ac2, and is divided into a plurality of wirings in the first coupling area Ac1. For example, each of the first constant voltage wiring 42 and the second constant voltage wiring 43 is divided into eight wirings in the first coupling area Ac1. The plurality of first constant voltage wirings 42 in the first coupling area Ac1 are arranged along the Y-axis at intervals from each other. Similarly, the plurality of second constant voltage wirings 43 in the first coupling area Ac1 are arranged along the Y-axis at intervals from each other.

By dividing each of the first constant voltage wiring 42 and the second constant voltage wiring 43 into a plurality of wirings in the first coupling area Ac1, the surface area to which adhesive adheres when the plurality of wirings are coupled can be increased. As a result, the flexible substrate 4 is less likely to peel off from the piezoelectric substrate 30, and the breaking of the first constant voltage wiring 42 and the second constant voltage wiring 43 can be suppressed. Furthermore, since each of the first constant voltage wiring 42 and the second constant voltage wiring 43 is divided into a plurality of wirings in the first coupling area Ac1, a contact failure can be suppressed even when misalignment occurs when coupling to the coupling electrode 381 of the piezoelectric substrate 30 in the first coupling area Ac1.

In the following, the first constant voltage wiring 42 and the second constant voltage wiring 43 in the first coupling area Ac1 may be referred to as a plurality of first constant voltage wirings 42 and a plurality of second constant voltage wirings 43. Note that the number of first constant voltage wirings 42 and second constant voltage wirings 43 in the first coupling area Ac1 is not limited to eight, but may be one or any number other than eight. Further, the first constant voltage wiring 42 and the second constant voltage wiring 43 may also be divided into a plurality of wirings in the second coupling area Ac2 on the input side located in the Z2 direction.

Each of the first constant voltage wiring 42 and the second constant voltage wiring 43 is held at a constant voltage. A reference voltage signal VBS is applied to each of the first constant voltage wiring 42 and the second constant voltage wiring 43. The potential of the reference voltage signal VBS may be the ground potential GND or may be a potential different from the ground potential GND. In the present embodiment, a case where the potential of the reference voltage signal VBS is higher than the ground potential GND is assumed. For example, in the present embodiment, a case where the potential of the reference voltage signal VBS is about 6 V is assumed. The plurality of first constant voltage wirings 42 and the plurality of second constant voltage wirings 43 are electrically coupled to a common electrode 52.

The first analog signal wiring 44 is disposed outside the first constant voltage wiring 42. The second analog signal wiring 45 is a wiring different from the first analog signal wiring 44 and is disposed outside the second constant voltage wiring 43. Each of the first analog signal wiring 44 and the second analog signal wiring 45 transmits an analog signal. For example, the potential of the analog signal transmitted through the first analog signal wiring 44 is a potential Vi1, and the potential of the analog signal transmitted through the second analog signal wiring 45 is the ground potential GND. Note that two or more first analog signal wirings 44 may be provided. Similarly, two or more second analog signal wirings 45 may be provided.

The materials of the plurality of drive signal wirings 41, the plurality of first constant voltage wirings 42, the plurality of second constant voltage wirings 43, the first analog signal wirings 44, and the second analog signal wirings 45 are not particularly limited as long as they are conductive materials, and include metals such as gold (Au), copper (Cu), titanium (Ti), tungsten (W), nickel (Ni), chromium (Cr), platinum (Pt), and aluminum (Al), for example.

In the present embodiment, the maximum voltage applied to the drive signal wiring 41 is, for example, about 42 V. However, the voltages applied to the wirings such as the drive signal wiring 41, the first constant voltage wiring 42, and the second constant voltage wiring 43 are not limited to the above example, and may be set as desired. The first constant voltage wiring 42 and the second constant voltage wiring 43 may be wirings to which the ground potential GND is supplied or wirings to which a constant voltage is applied, such as a power supply voltage for various components.

In the present embodiment, the plurality of drive signal wirings 41 are interposed between the first constant voltage wirings 42 and the second constant voltage wirings 43 in the direction along the Y-axis. Therefore, it is possible to more effectively suppress the influence of noise generated in the plurality of drive signal wirings 41 on the first analog signal wiring 44 and the second analog signal wiring 45.

Note that, for example, the second analog signal wiring 45 may not be provided. In this case, the plurality of drive signal wirings 41 do not need to be interposed between the first constant voltage wiring 42 and the second constant voltage wiring 43. In this case, the first analog signal wiring 44 only needs to be disposed outside the first constant voltage wiring 42.

Furthermore, in the present embodiment, the flexible substrate 4 does not have any other wiring between an end side 400S of the flexible substrate 4 in the Y1 direction and the first analog signal wiring 44 in the direction along the Y-axis. That is, the first analog signal wiring 44 is provided on the outermost side of the flexible substrate 4 in the Y-axis. The end side 400S is a side that extends in a direction that intersects with the extension direction of the first nozzle row La and along the Y-Z plane.

By providing the first analog signal wiring 44 on the outermost side of the flexible substrate 4, noise from other wirings can be suppressed from being carried onto the first analog signal wiring 44.

Similarly, the flexible substrate 4 does not have any other wiring between an end side 400S of the flexible substrate 4 in the Y2 direction and the second analog signal wiring 45 in the direction along the Y-axis. That is, the second analog signal wiring 45 is provided on the outermost side of the flexible substrate 4 in the Y-axis. By providing the second analog signal wiring 45 on the outermost side of the flexible substrate 4, noise from other wirings can be suppressed from being carried onto the second analog signal wiring 45.

Here, when migration occurs due to moisture adhering to the flexible substrate 4 or due to the flexible substrate 4 being exposed to a high humidity environment, or when the flexible substrate 4 is exposed to outgassing containing sulfur, there is a concern that the drive signal wirings 41 may be coupled to each other and cause a short circuit.

For example, sulfur vulcanized in butyl rubber, such as in an ink cap used in the liquid ejecting apparatus 100, reacts with the solvent in the solvent-based ink to generate sulfide gas from the butyl rubber, and when the sulfide gas flows into the inside of the liquid ejecting head 200 through an opening or the like in a connector, the wiring of the flexible substrate 4 is exposed to a sulfide gas atmosphere. In this case, the wiring of the flexible substrate 4 adsorbs the sulfide gas, and the copper (Cu) portion of the wiring that has adsorbed the sulfide gas corrodes, thereby forming copper sulfide (CuS). As the formation of copper sulfide progresses, the drive signal wirings 41 having a narrow interval between the wirings are electrically coupled to each other, causing a short circuit.

Further, for example, in a case in which UV ink containing a monomer or the like that is cured by ultraviolet irradiation is used, when the monomer contained in the UV ink permeates the adhesive that couples the flow paths, the space that accommodates the flexible substrate 4 becomes highly humid. In this case, the portion of the wiring of the flexible substrate 4 that is exposed to the space that accommodates the flexible substrate 4 is exposed to high humidity air, and thus there is a concern that migration may occur in the wiring in the portion exposed to the space that accommodates the flexible substrate 4, causing a short circuit between the wirings.

When a short circuit occurs between the drive signal wirings 41, the drive signal Vout cannot be transmitted appropriately to the piezoelectric element E, resulting in a liquid ejection failure or a serious error. Therefore, in the present embodiment, by detecting short circuits between wirings that are more likely to short-circuit than between drive signal wirings 41, the life of the flexible substrate 4 is predicted before a short circuit occurs between the drive signal wirings 41, thereby suppressing the occurrence of liquid ejection failures or serious errors. In the present embodiment, the first constant voltage wiring 42 and the first analog signal wiring 44 are used as wirings that are more likely to short-circuit than the drive signal wirings 41.

For example, in the present embodiment, the first constant voltage wiring 42 and the first analog signal wiring 44 are wirings disposed at one end of a plurality of wirings provided on the flexible substrate 4 and arranged in the direction along the Y-axis. That is, the first constant voltage wiring 42 and the first analog signal wiring 44 are disposed outside the plurality of drive signal wirings 41 in the direction along the Y-axis, and are located at the end portion of the flexible substrate 4 in the direction along the Y-axis. Furthermore, for example, when the wiring of the flexible substrate 4 is exposed to a sulfide gas atmosphere, copper sulfide is considered to be formed from the end portion of the flexible substrate 4 by the sulfide gas atmosphere. Therefore, it is considered that the adjacent first constant voltage wiring 42 and first analog signal wiring 44 disposed at the end portion of the flexible substrate 4 will short-circuit before the plurality of drive signal wiring 41 disposed in the center portion of the flexible substrate 4 in the direction along the Y-axis. Therefore, in the present embodiment, by detecting a short circuit between the first constant voltage wiring 42 and the first analog signal wiring 44, it is possible to predict the life of the flexible substrate 4 before a short circuit occurs between the drive signal wirings 41, which directly affects the liquid ejection characteristics. That is, in the present embodiment, by detecting a short circuit between the first constant voltage wiring 42 and the first analog signal wiring 44, it is possible to predict the life of the flexible substrate 4 before a liquid ejection failure occurs due to a short circuit between the drive signal wirings 41. As a result, in the present embodiment, it is possible to suppress the occurrence of liquid ejection failures and serious errors. Furthermore, in the present embodiment, it is possible to prompt a user to replace the liquid ejecting head 200 before a liquid ejection failure or a serious error occurs.

It is preferable that an interval D1 between the first constant voltage wiring 42 and the first analog signal wiring 44 is the smallest interval between adjacent wirings on the flexible substrate 4. For example, it is preferable that the interval D1 between the first constant voltage wiring 42 and the first analog signal wiring 44 is narrower than an interval D3 between the first constant voltage wiring 42 and the drive signal wiring 41 and an interval D4 between adjacent drive signal wirings 41. Furthermore, it is preferable that the interval D1 between the first constant voltage wiring 42 and the first analog signal wiring 44 is narrower than the interval between the wirings at which migration is likely to occur when the potential difference between adjacent wirings is taken into consideration. For example, it is preferable that the interval D1 between the first constant voltage wiring 42 and the first analog signal wiring 44 is narrower than an interval D5 between the two wirings to which the high potential VHV and the ground potential GND are respectively supplied. Furthermore, it is preferable that an interval D10 between the first constant voltage wiring 42 and the first analog signal wiring 44 in the second coupling area Ac2 is narrower than the interval D5 between the two wirings to which the high potential VHV and the ground potential GND are respectively supplied.

In an aspect in which the interval D1 between the first constant voltage wiring 42 and the first analog signal wiring 44 is narrower than the interval between the other wirings, a short circuit between the first constant voltage wiring 42 and the first analog signal wiring 44 can be intentionally generated the earliest among the wirings of the flexible substrate 4. As a result, in the present aspect, the life of the flexible substrate 4 can be reliably predicted before a liquid ejection failure occurs due to a short circuit between the drive signal wirings 41, compared to when the interval D1 is wider than the interval D4. As the detection circuit 25 that detects a short circuit between the first constant voltage wiring 42 and the first analog signal wiring 44, a known circuit can be employed.

In an example shown in FIG. 7, an interval D2 between the adjacent first constant voltage wirings 42 is the same as the interval D4 between the adjacent drive signal wirings 41. However, the interval D2 may be narrower or wider than the interval D4. Furthermore, since the plurality of first constant voltage wirings 42 in the first coupling area Ac1 are wirings that are divided from a single first constant voltage wiring 42, the interval D2 may be narrower than the interval D1 between the first constant voltage wiring 42 and the first analog signal wiring 44. As shown in FIG. 7, it is preferable that the interval D3 between the first constant voltage wiring 42 and the drive signal wiring 41 is wider than the interval D4 between the adjacent drive signal wirings 41.

### 1-6. Detection Circuit 25

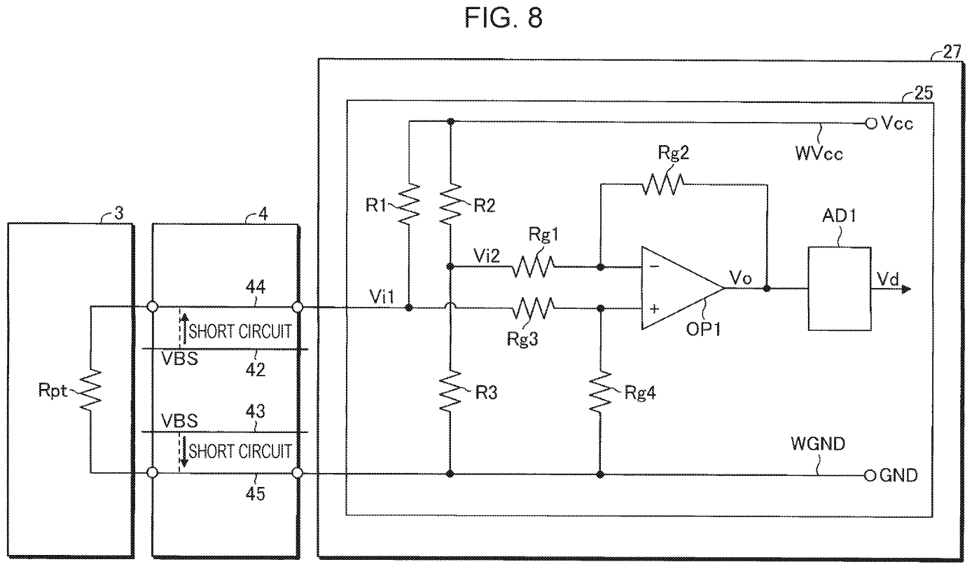

FIG. 8 is a view showing an example of the detection circuit 25 shown in FIG. 2. In FIG. 8, the first resistance wiring 46 and the second resistance wiring 47 coupled in parallel are shown as a resistance element Rpt. That is, the resistance element Rpt represents the combined resistance of the first resistance wiring 46 and the second resistance wiring 47 coupled in parallel. The detection circuit 25 is coupled to one end of the resistance element Rpt via the first analog signal wiring 44 of the flexible substrate 4, and is coupled to the other end of the resistance element Rpt via the second analog signal wiring 45 of the flexible substrate 4.

The detection circuit 25 has, for example, resistance elements R1, R2, R3, Rg1, Rg2, Rg3, and Rg4, an operational amplifier OP1, and an analog-to-digital conversion circuit AD1. The high power supply potential of the detection circuit 25 is a power supply potential Vcc, and the low power supply potential of the detection circuit 25 is a ground potential GND. The power supply potential Vcc is, for example, 3.3 V.

A potential Vi2 divided by the resistance elements R2 and R3 coupled in series between a wiring WVcc to which the power supply potential Vcc is supplied and a wiring WGND to which the ground potential GND is supplied is input to the inverting input terminal of the operational amplifier OP1 via the resistance element Rg1. For example, a coupling node between the resistance element R2, one end of which is coupled to the wiring WVcc, and the resistance element R3, one end of which is coupled to the wiring WGND, is coupled to one end of the resistance element Rg1, and the other end of the resistance element Rg1 is coupled to the inverting input terminal of the operational amplifier OP1. Furthermore, an output signal Vo of the operational amplifier OP1 is fed back to the inverting input terminal of the operational amplifier OP1 via the resistance element Rg2.

The potential Vi1 of the first analog signal wiring 44, which is coupled to the wiring WVcc via the resistance element R1, is input to a non-inverting input terminal of the operational amplifier OP1 via the resistance element Rg3. For example, one end of the resistance element R1 is coupled to the wiring WVcc, the other end of the resistance element R1 is coupled to one end of the resistance element Rg3 and one end of the first analog signal wiring 44, and the other end of the resistance element Rg3 is coupled to the non-inverting input terminal of the operational amplifier OP1. The other end of the first analog signal wiring 44 is coupled to one end of the resistance element Rpt. The non-inverting input terminal of the operational amplifier OP1 is coupled to the wiring WGND via the resistance element Rg4.

Furthermore, one end of the second analog signal wiring 45 is coupled to the wiring WGND, and the other end of the second analog signal wiring 45 is coupled to the resistance element Rpt. That is, when the resistance of the first analog signal wiring 44 and the resistance of the second analog signal wiring 45 are ignored, the potential Vi1 is a potential obtained by dividing the power supply potential Vcc by the resistance element R1 and the resistance element Rpt. As described above, the potential Vi2 is a potential obtained by dividing the power supply potential Vcc by the resistance element R2 and the resistance element R3.

Also, the output signal Vo is a signal obtained by amplifying the potential difference between the potential Vi1 and the potential Vi2 by a gain determined based on the resistance elements Rg1 and Rg2. The output signal Vo is converted from an analog signal to a digital signal by the analog-to-digital conversion circuit AD1 and output as the detection signal Vd.

In this way, in the present embodiment, the potential Vi1 of the analog signal transmitted through the first analog signal wiring 44 is a potential obtained by dividing the power supply potential Vcc by the resistance element R1 and the resistance element Rpt. Therefore, the potential Vi1 of the analog signal transmitted through the first analog signal wiring 44 is lower than the power supply potential Vcc of 3.3 V. Further, the potential Vi1 of the analog signal transmitted through the first analog signal wiring 44 is a potential that changes in accordance with a change in the temperature of the pressure chamber C1, as will be described later. In the present embodiment, the potential of the first constant voltage wiring 42, that is, the potential of the reference voltage signal VBS, is about 6 V, which is higher than the power supply potential Vcc. In this way, the potential of the first constant voltage wiring 42 is held at a potential different from the potential Vi1 of the analog signal transmitted through the first analog signal wiring 44. In the present embodiment, the first constant voltage wiring 42 is an example of a “first wiring”.

Here, for example, when the first analog signal wiring 44 and the second analog signal wiring 45 are not short-circuited to other wirings, the potential Vi1 obtained by dividing the power supply potential Vcc by the resistance element R1 and the resistance element Rpt changes in accordance with changes in the resistance value of the resistance element Rpt. The resistance value of the resistance element Rpt is the combined resistance value of the first resistance wiring 46 and the second resistance wiring 47 coupled in parallel, and therefore changes in accordance with the temperature change of the pressure chamber C1. Accordingly, the potential Vi1 changes in accordance with the temperature change of the pressure chamber C1. Therefore, the detection signal Vd obtained by converting the output signal Vo corresponding to the potential difference between the potential Vi1 and the potential Vi2 into a digital signal also changes in accordance with the temperature change of the pressure chamber C1. Therefore, in the present embodiment, by detecting the detection signal Vd, the temperature of the pressure chamber C1 can be detected as the state of the piezoelectric substrate 30. In the following, the change in the detection signal Vd in accordance with the temperature change in the pressure chamber C1 when the first analog signal wiring 44 and the second analog signal wiring 45 are not short-circuited to other wiring may be referred to as the change in the detection signal Vd in a normal state.

Further, for example, when the first analog signal wiring 44 and the first constant voltage wiring 42 of the flexible substrate 4 are short-circuited, the reference voltage signal VBS is supplied from the first constant voltage wiring 42 to the first analog signal wiring 44. Therefore, the potential Vi1 changes to the potential corresponding to the reference voltage signal VBS. For example, when the potential of the reference voltage signal VBS is about 6 V, the potential Vi1 also changes to about 6 V. In this way, when the first analog signal wiring 44 and the first constant voltage wiring 42 are short-circuited, the change in the detection signal Vd behaves differently from the change in the detection signal Vd in a normal state.

Furthermore, for example, even when the second analog signal wiring 45 and the second constant voltage wiring 43 of the flexible substrate 4 are short-circuited, the change in the detection signal Vd behaves differently from the change in the detection signal Vd in the normal state. Therefore, in the present embodiment, by detecting the detection signal Vd, it is possible to detect a short circuit or the like between the first analog signal wiring 44 and the first constant voltage wiring 42. For example, the control circuit 11 determines a short circuit between the first constant voltage wiring 42 and the first analog signal wiring 44 of the flexible substrate 4 based on the detection signal Vd. For example, when the control circuit 11 detects a short circuit between the first constant voltage wiring 42 and the first analog signal wiring 44, the control circuit 11 may notify a user of a warning prompting replacement of the liquid ejecting head 200. The control circuit 11 is an example of a “determination circuit”.

In this way, in the present embodiment, the first analog signal wiring 44 used to detect the temperature of the liquid ejecting head 200 also serves as one of the wirings for detecting short circuits between the wirings of the flexible substrate 4. Furthermore, the detection circuit 25 for detecting the temperature of the liquid ejecting head 200 also serves as a circuit for detecting a short circuit or the like between the first analog signal wiring 44 and the first constant voltage wiring 42. Accordingly, in the present embodiment, the liquid ejecting head 200 can be made smaller than in an aspect in which a circuit for detecting a short circuit or the like between the first analog signal wiring 44 and the first constant voltage wiring 42 is provided separately from the detection circuit 25. Furthermore, in the present embodiment, the first constant voltage wiring 42, which is commonly coupled to the plurality of piezoelectric elements E and supplies the reference voltage signal VBS to the plurality of piezoelectric elements E, also serves as one of the wirings for detecting short circuits between wirings on the flexible substrate 4. Accordingly, in the present embodiment, it is possible to suppress an increase in size of the flexible substrate 4.

The configuration of the detection circuit 25 is not limited to the example shown in FIG. 8. Furthermore, in the present embodiment, a case where a plurality of detection circuits 25 corresponding to a plurality of liquid ejecting modules 20 are provided is assumed, but a single detection circuit 25 common to a plurality of liquid ejecting modules 20 may also be provided. In this case, among the plurality of liquid ejecting modules 20, the liquid ejecting module 20 including the first analog signal wiring 44 and the second analog signal wiring 45 coupled to the detection circuit 25 may be switchable by a selection circuit including, for example, a switch.

Furthermore, in a case in which the withstand voltage of each element of the detection circuit 25 is less than 6 V, when the first analog signal wiring 44 and the first constant voltage wiring 42 of the flexible substrate 4 are short-circuited, a reference voltage signal VBS with a potential higher than the withstand voltage is supplied to the detection circuit 25. Therefore, when a short circuit occurs between the first analog signal wiring 44 and the first constant voltage wiring 42 of the flexible substrate 4, there is a concern that the elements of the detection circuit 25 may be destroyed, and the detection signal Vd may not be output or an abnormal value of the detection signal Vd may be output. In this case, by detecting that the detection signal Vd is not output or that an abnormal value of the detection signal Vd is output, it is possible to detect a short circuit between the first analog signal wiring 44 and the first constant voltage wiring 42 of the flexible substrate 4. In the present embodiment, since a short circuit between the first constant voltage wiring 42 and the first analog signal wiring 44 is detected before a short circuit occurs between the drive signal wirings 41, even when an element of the detection circuit 25 is destroyed, there is a high likelihood that the head chip 3 will not fail. When the head chip 3 does not fail, it may be reused.

### 1-7. Summary of the First Embodiment

As described above, in the present embodiment, the liquid ejecting head 200 includes the piezoelectric substrate 30 having the plurality of piezoelectric elements E for ejecting the liquid, the wiring substrate 27, and the flexible substrate 4 that electrically couples the piezoelectric substrate 30 and the wiring substrate 27. The flexible substrate 4 has the plurality of drive signal wirings 41 arranged in the direction along the Y-axis, which transmit the drive signal Vout that drives each of the plurality of piezoelectric elements E, the first analog signal wiring 44 which transmits an analog signal, and the first constant voltage wiring 42 which is held at the potential of the reference voltage signal VBS which is different from the potential Vi1 of the analog signal transmitted through the first analog signal wiring 44. The wiring substrate 27 includes the detection circuit 25 that outputs the detection signal Vd for detecting the state of the piezoelectric substrate 30 based on the analog signal transmitted via the first analog signal wiring 44. The first analog signal wiring 44 is adjacent to the first constant voltage wiring 42 and disposed outside the plurality of drive signal wirings 41 in the direction along the Y-axis.

In this way, in the present embodiment, the detection circuit 25 outputs the detection signal Vd for detecting the state of the piezoelectric substrate 30 based on the analog signal transmitted via the first analog signal wiring 44. When the first analog signal wiring 44 and the first constant voltage wiring 42 are short-circuited, the potential of the analog signal transmitted through the first analog signal wiring 44 changes. Therefore, in the present embodiment, a short circuit between the first analog signal wiring 44 and the first constant voltage wiring 42 can be detected based on the detection signal Vd. In the present embodiment, the first analog signal wiring 44 of the flexible substrate 4 is adjacent to the first constant voltage wiring 42 and disposed outside the plurality of drive signal wirings 41 in the direction along the Y-axis. For example, gas containing sulfur components and humidity is likely to enter from the outside in the direction along the Y-axis, which is the arrangement direction of the plurality of drive signal wirings 41. Therefore, the first analog signal wiring 44 and the first constant voltage wiring 42 disposed outside the plurality of drive signal wirings 41 are more likely to short-circuit than the drive signal wirings 41 adjacent to each other.

Therefore, in the present embodiment, by detecting a short circuit between the first constant voltage wiring 42 and the first analog signal wiring 44, it is possible to predict the life of the flexible substrate 4 before a liquid ejection failure occurs due to a short circuit between the drive signal wirings 41. As a result, in the present embodiment, it is possible to suppress the occurrence of liquid ejection failures and serious errors. Furthermore, in the present embodiment, it is possible to prompt a user to replace the liquid ejecting head 200 before a liquid ejection failure or a serious error occurs. Furthermore, in the present embodiment, the detection circuit 25 for detecting the state of the piezoelectric substrate 30 also serves as a circuit for detecting a short circuit between the first analog signal wiring 44 and the first constant voltage wiring 42. Therefore, in the present embodiment, the liquid ejecting head 200 can be made smaller than in an aspect in which a circuit for detecting a short circuit between the first analog signal wiring 44 and the first constant voltage wiring 42 is provided separately from the detection circuit 25.

In the present embodiment, the first constant voltage wiring 42 is a constant potential wiring that is coupled in common to the plurality of piezoelectric elements E and is held at the potential of the reference voltage signal VBS as a constant potential. In this way, in the present embodiment, the first constant voltage wiring 42, which is commonly coupled to the plurality of piezoelectric elements E and supplies the reference voltage signal VBS to the plurality of piezoelectric elements E, also serves as one of the wirings for detecting short circuits between wirings on the flexible substrate 4. Accordingly, in the present embodiment, it is possible to suppress an increase in size of the flexible substrate 4.

In addition, in the present embodiment, the liquid ejecting apparatus 100 includes the above-described liquid ejecting head 200 and a control circuit 11 that determines a short circuit between the first wiring of the flexible substrate 4 and the first analog signal wiring 44 based on the detection signal Vd. Accordingly, by detecting a short circuit between the first constant voltage wiring 42 and the first analog signal wiring 44, the liquid ejecting apparatus 100 can predict the life of the flexible substrate 4 before a liquid ejection failure occurs due to a short circuit between the drive signal wirings 41.

### 2. Modification Examples

Each of the above forms can be modified in various ways. Specific aspects of modification examples are exemplified below. Two or more aspects selected in any manner from the following examples can be combined with each other as appropriate within a range not inconsistent with each other. In addition, in the modification examples exemplified below, elements having the same effects and functions as those of the embodiment will be given the reference numerals used in the description above, and each detailed description thereof will be omitted as appropriate.

### 2-1. First Modification Example

In the above-described embodiment, an example was given of the case where the detection circuit 25 detects a short circuit between the first constant voltage wiring 42 and the first analog signal wiring 44, but the present disclosure is not limited to such an aspect. For example, the detection circuit 25 may detect a short circuit between the first analog signal wiring 44 and a wiring held at a potential lower than the potential Vi1 of the analog signal transmitted through the first analog signal wiring 44.

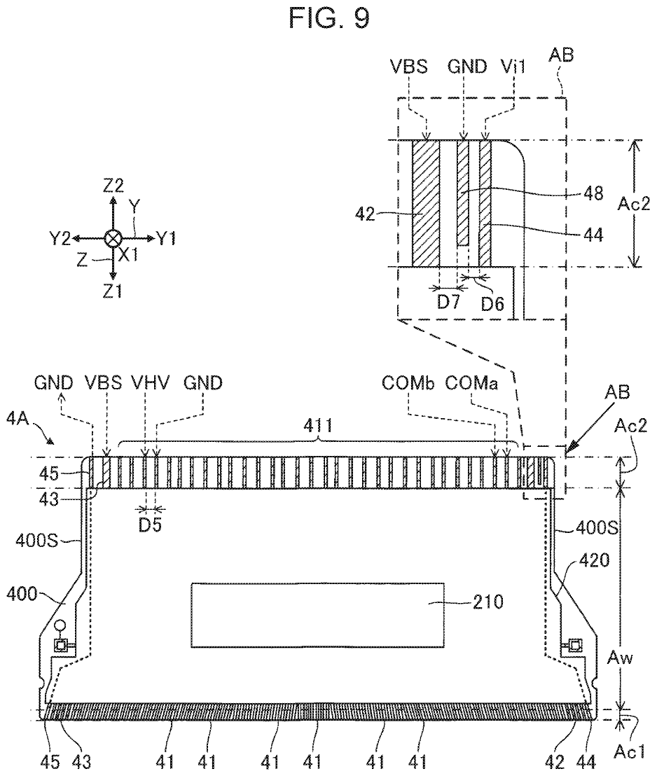

FIG. 9 is a view showing a flexible substrate 4A according to a first modification example. FIG. 9 also shows an enlarged view of an area AB enclosed by a broken line. The flexible substrate 4A is similar to the flexible substrate 4 shown in FIG. 7, except that a dummy wiring 48 held at ground potential GND is disposed adjacent to the first analog signal wiring 44 in the second coupling area Ac2. Moreover, a liquid ejecting module 20 according to the present modification example is similar to the liquid ejecting module 20 according to the embodiment described above, except that a flexible substrate 4A is provided instead of the flexible substrate 4 shown in FIG. 7. In FIG. 9, differences between the flexible substrate 4A and the flexible substrate 4 will be mainly described.

In the flexible substrate 4A, the dummy wiring 48 adjacent to the first analog signal wiring 44 is disposed in the second coupling area Ac2. For example, the dummy wiring 48 is disposed between the first constant voltage wiring 42 and the first analog signal wiring 44 in the direction along the Y-axis. Other configurations of the flexible substrate 4A are similar to those of the flexible substrate 4 shown in FIG. 7. In the present modification example, the interval D1 between the first constant voltage wiring 42 and the first analog signal wiring 44 shown in FIG. 7 may be narrower than the interval D4 between adjacent drive signal wirings 41, or may be equal to or greater than the interval D4.

The potential of the dummy wiring 48 is held at a potential lower than the potential of the reference voltage signal VBS, for example. Preferably, the potential of the dummy wiring 48 is held at a potential lower than the potential Vi1 of the analog signal transmitted through the first analog signal wiring 44. More preferably, the potential of the dummy wiring 48 is held at the ground potential GND. For example, the end portion of the dummy wiring 48 in the Z2 direction is coupled to a terminal (not shown) to which the ground potential GND of the wiring substrate 27 is supplied, and the end portion of the dummy wiring 48 in the Z1 direction is open. Accordingly, the potential of the dummy wiring 48 is held at the ground potential GND, which is lower than the potential Vi1 of the analog signal transmitted through the first analog signal wiring 44. In an example shown in FIG. 9, the end portion of the dummy wiring 48 in the Z1 direction is located in the Z2 direction further than the cover film 420, but the end portion of the dummy wiring 48 in the Z1 direction may also be covered by the cover film 420.

In this way, in the present modification example, the dummy wiring 48 and the first analog signal wiring 44 are wirings disposed at one end of a plurality of wirings provided in the second coupling area Ac2 of the flexible substrate 4 and arranged in the direction along the Y-axis. That is, the dummy wiring 48 and the first analog signal wiring 44 are disposed outside the plurality of wirings 411 in the direction along the Y-axis, and are located at the end portion of the flexible substrate 4 in the direction along the Y-axis. Therefore, in the present modification example as well, as in the above-described embodiment, by detecting a short circuit between the dummy wiring 48 and the first analog signal wiring 44, it is possible to predict the life of the flexible substrate 4 before a liquid ejection failure occurs due to a short circuit between the drive signal wirings 41.

It is preferable that an interval D6 between the dummy wiring 48 and the first analog signal wiring 44 is the smallest interval between adjacent wirings on the flexible substrate 4. For example, it is preferable that the interval D6 between the dummy wiring 48 and the first analog signal wiring 44 is narrower than an interval D7 between the dummy wiring 48 and the first constant voltage wiring 42. Furthermore, it is preferable that the interval D6 between the dummy wiring 48 and the first analog signal wiring 44 is narrower than the interval D4 between the adjacent drive signal wirings 41. Furthermore, it is preferable that the interval D6 between the dummy wiring 48 and the first analog signal wiring 44 is narrower than the interval between the wirings at which migration is likely to occur when the potential difference between adjacent wirings is taken into consideration. For example, it is preferable that the interval D6 between the dummy wiring 48 and the first analog signal wiring 44 is narrower than an interval D5 between the two wirings to which the high potential VHV and the ground potential GND are respectively supplied.

In an aspect in which the interval D6 between the dummy wiring 48 and the first analog signal wiring 44 is narrower than the interval between the other wirings, a short circuit between the dummy wiring 48 and the first analog signal wiring 44 can be intentionally generated the earliest among the wirings of the flexible substrate 4. As a result, in the present aspect, the life of the flexible substrate 4 can be reliably predicted before a liquid ejection failure occurs due to a short circuit between the drive signal wirings 41, compared to when, for example, the interval D6 is wider than the interval D4.

As can be seen from FIG. 8, the potential Vi1 of the first analog signal wiring 44 is a potential obtained by dividing the power supply potential Vcc by the resistance element R1 and the resistance element Rpt, and is therefore higher than the ground potential GND held in the dummy wiring 48. Since the ground potential GND, which is a potential different from the potential Vi1 of the first analog signal wiring 44, is held in the dummy wiring 48, when the dummy wiring 48 and the first analog signal wiring 44 are short-circuited, the change in the detection signal Vd behaves differently from the change in the detection signal Vd in the normal state. On the other hand, the second analog signal wiring 45 is supplied with the ground potential GND. Therefore, in an aspect in which the dummy wiring 48 held at the ground potential GND is disposed adjacent to the second analog signal wiring 45, it is difficult to distinguish between the change in the detection signal Vd when the dummy wiring 48 and the second analog signal wiring 45 are short-circuited and the change in the detection signal Vd in the normal state. Therefore, in the present modification example, the dummy wiring 48 is disposed adjacent to the first analog signal wiring 44, but is not disposed adjacent to the second analog signal wiring. Accordingly, in the present modification example, a short circuit between the dummy wiring 48 and the first analog signal wiring 44 can be easily detected as a short circuit between wirings on the flexible substrate 4. Furthermore, in the present modification example, the dummy wiring 48 is not disposed adjacent to the second analog signal wiring, so that an increase in the number of dummy wirings 48 can be suppressed, and an increase in size of the flexible substrate 4 can be suppressed.

Further, for example, the withstand voltage of the elements of the detection circuit 25 is generally higher than the power supply potential Vcc. Since the potential of the dummy wiring 48 is the ground potential GND, the potential is lower than the withstand voltage of the elements of the detection circuit 25. For example, in the present modification example, even when the dummy wiring 48 and the first analog signal wiring 44 are short-circuited, the potential of the dummy wiring 48 is the ground potential GND, and thus the potential of the first analog signal wiring 44 is lower than the power supply potential Vcc and the withstand voltage of the elements of the detection circuit 25. Therefore, in the present modification example, it is possible to prevent the elements of the detection circuit 25 from being destroyed when the dummy wiring 48 and the first analog signal wiring 44 are short-circuited. Therefore, in the present modification example, when the liquid ejecting head 200 is refurbished, the wiring substrate 27 including the detection circuit 25 can be reused.

In the present modification example, the dummy wiring 48 is an example of a “first wiring”, the first constant voltage wiring 42 is an example of a “constant potential wiring”, and the first resistance wiring 46 and the second resistance wiring 47 are examples of “relay wirings”. In the present modification example, the ground potential GND, which is the potential of the dummy wiring 48, is an example of a “first potential”, and the potential of the reference voltage signal VBS is an example of a “second potential”.

The configuration of the flexible substrate 4A is not limited to the example shown in FIG. 9. For example, the potential held in the dummy wiring 48 is not limited to the ground potential GND. Specifically, for example, the potential held in the dummy wiring 48 may be a potential lower than the potential Vi1 of the analog signal transmitted through the first analog signal wiring 44. In the present aspect as well, when the dummy wiring 48 and the first analog signal wiring 44 are short-circuited, the potential of the first analog signal wiring 44 is suppressed from becoming higher than the power supply potential Vcc. Therefore, in the present aspect as well, it is possible to suppress the destruction of the elements of the detection circuit 25 when the dummy wiring 48 and the first analog signal wiring 44 are short-circuited. Further, the withstand voltage of the elements of the detection circuit 25 may have a margin with respect to the power supply potential Vcc. Therefore, the potential held in the dummy wiring 48 may be a potential higher than the potential Vi1 of the analog signal transmitted through the first analog signal wiring 44, as long as it is lower than the withstand voltage of the elements of the detection circuit 25.

As described above, in the present modification example as well, the same effect as that of the embodiment described above can be obtained. In the present modification example, another dummy wiring 48 separate from the first constant voltage wiring 42 to which the reference voltage signal VBS is supplied is used to detect short circuits between the wirings of the flexible substrate 4. For example, a potential held in the dummy wiring 48 is lower than a potential of the reference voltage signal VBS. In the present modification example, a short circuit between another dummy wiring 48 separate from the first constant voltage wiring 42 and the first analog signal wiring 44 is detected, so that changes in the liquid ejection characteristics can be suppressed when a short circuit occurs between the dummy wiring 48 and the first analog signal wiring 44.

In the present modification example, the potential held in the dummy wiring 48 is lower than the potential Vi1 of the analog signal transmitted through the first analog signal wiring 44. For example, in the present modification example, the potential held in the dummy wiring 48 is the ground potential GND. In the present modification example, the potential held in the dummy wiring 48 is set to a potential lower than the potential Vi1 of the analog signal transmitted through the first analog signal wiring 44, for example, the ground potential GND, thereby preventing failure of the detection circuit 25. Furthermore, when the potential held in the dummy wiring 48 is the ground potential GND, there is no need for a circuit to generate a potential used only to detect short circuits between the wirings of the flexible substrate 4, and thus it is possible to suppress the complication of the liquid ejecting head 200.

In addition, in the present modification example, the dummy wiring 48 is disposed adjacent to the first analog signal wiring 44, but is not disposed adjacent to the second analog signal wiring. Therefore, in the present modification example, an increase in the number of dummy wirings 48 can be suppressed, and an increase in size of the flexible substrate 4 can be suppressed.

In the present modification example, the dummy wiring 48 is disposed between the first constant voltage wiring 42 and the first analog signal wiring 44 in the direction along the Y-axis. In this way, in the present modification example, the dummy wiring 48 is not disposed outside the first analog signal wiring 44 in the direction along the Y-axis, and therefore an increase in size of the flexible substrate 4 can be suppressed.

Furthermore, in the present modification example, the interval D6 between the dummy wiring 48 and the first analog signal wiring 44 is narrower than the interval D7 between the dummy wiring 48 and the first constant voltage wiring 42 in the direction along the Y-axis. Accordingly, in the present modification example, a short circuit between the dummy wiring 48 and the first analog signal wiring 44 is more likely to occur than a short circuit between the dummy wiring 48 and the first constant voltage wiring 42. Therefore, in the present modification example, the life of the flexible substrate 4 can be predicted before a short circuit occurs between the dummy wiring 48 and the first constant voltage wiring 42.

In the present modification example, one end of the dummy wiring 48 is coupled to a terminal (not shown) to which the ground potential GND of the wiring substrate 27 is supplied, and the other end of the dummy wiring 48 is open. Accordingly, in the present modification example, it is possible to easily ensure space on the flexible substrate 4 for routing the dummy wiring 48 used to detect short circuits between the wirings of the flexible substrate 4.

In the present modification example, the dummy wiring 48 and the first analog signal wiring 44 are wirings disposed at one end of a plurality of wirings provided on the flexible substrate 4 and arranged in the direction along the Y-axis. In this way, in the present modification example as well, the dummy wiring 48 and the first analog signal wiring 44 used to detect short circuits between the wirings of the flexible substrate 4 are disposed at the end portion of the flexible substrate 4. Therefore, in the present modification example, a short circuit between the dummy wiring 48 and the first analog signal wiring 44 is more likely to occur than a short circuit between other wirings.

### 2-2. Second Modification Example

In the above-described modification example, an example was given of the case where the dummy wiring 48 is disposed between the first constant voltage wiring 42 and the first analog signal wiring 44, but the present disclosure is not limited to such an aspect. For example, the dummy wiring 48 may be disposed outside the first analog signal wiring 44 in the direction along the Y-axis.

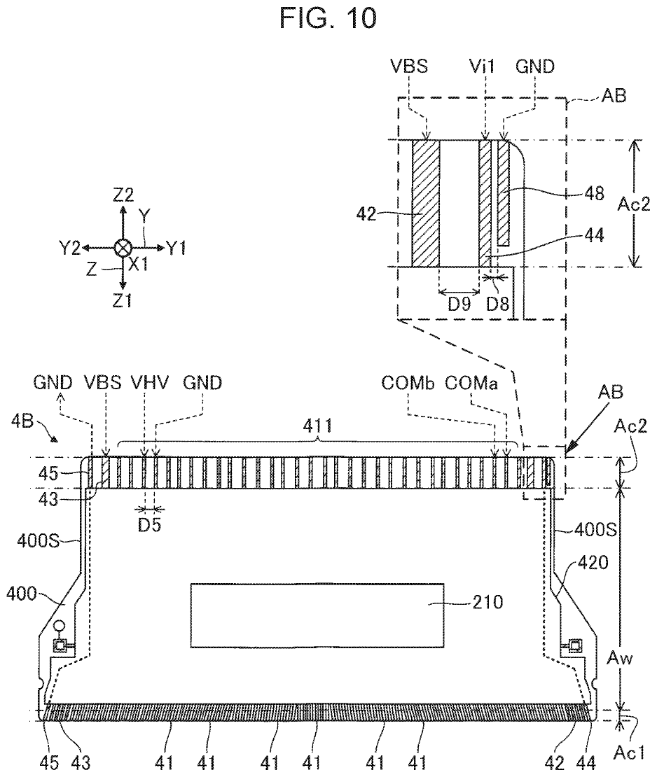

FIG. 10 is a view showing a flexible substrate 4B according to a second modification example. FIG. 10 also shows an enlarged view of the area AB enclosed by the broken line. The flexible substrate 4B is similar to the flexible substrate 4A shown in FIG. 9, except that the dummy wiring 48 is disposed outside the first analog signal wiring 44 in the direction along the Y-axis. Moreover, a liquid ejecting module 20 according to the present modification example is similar to the liquid ejecting module 20 according to the embodiment described above, except that a flexible substrate 4B is provided instead of the flexible substrate 4 shown in FIG. 7. In FIG. 10, differences between the flexible substrate 4A and the flexible substrate 4B will be mainly described.

In the flexible substrate 4B, the dummy wiring 48 disposed in the second coupling area Ac2 is located outside the first analog signal wiring 44 in the direction along the Y-axis. That is, the first analog signal wiring 44 is disposed between the first constant voltage wiring 42 and the dummy wiring 48 in the direction along the Y-axis. Other configurations of the flexible substrate 4B are similar to those of the flexible substrate 4A shown in FIG. 9.

In this way, in the present modification example as well, the dummy wiring 48 and the first analog signal wiring 44 are wirings disposed at one end of a plurality of wirings provided in the second coupling area Ac2 of the flexible substrate 4 and arranged in the direction along the Y-axis. Therefore, in the present modification example as well, as in the above-described modification example, by detecting a short circuit between the dummy wiring 48 and the first analog signal wiring 44, it is possible to predict the life of the flexible substrate 4 before a liquid ejection failure occurs due to a short circuit between the drive signal wirings 41.

In the present modification example as well, it is preferable that an interval D8 between the dummy wiring 48 and the first analog signal wiring 44 is the smallest interval between adjacent wirings on the flexible substrate 4. For example, it is preferable that the interval D8 between the dummy wiring 48 and the first analog signal wiring 44 is narrower than an interval D9 between the dummy wiring 48 and the first constant voltage wiring 42. Furthermore, it is preferable that the interval D8 between the dummy wiring 48 and the first analog signal wiring 44 is narrower than the interval D4 between the adjacent drive signal wirings 41. Furthermore, it is preferable that the interval D8 between the dummy wiring 48 and the first analog signal wiring 44 is narrower than the interval between the wirings at which migration is likely to occur when the potential difference between adjacent wirings is taken into consideration. For example, it is preferable that the interval D8 between the dummy wiring 48 and the first analog signal wiring 44 is narrower than an interval D5 between the two wirings to which the high potential VHV and the ground potential GND are respectively supplied.

In an aspect in which the interval D8 between the dummy wiring 48 and the first analog signal wiring 44 is narrower than the interval between the other wirings, a short circuit between the dummy wiring 48 and the first analog signal wiring 44 can be intentionally generated the earliest among the wirings of the flexible substrate 4. As a result, in the present aspect, the life of the flexible substrate 4 can be reliably predicted before a liquid ejection failure occurs due to a short circuit between the drive signal wirings 41, compared to when, for example, the interval D8 is wider than the interval D4.

As described above, in the present modification example as well, the same effects as those of the embodiment and the modification example described above can be obtained.

### 2-3. Third Modification Example

In the above-described embodiment and modification examples, an example was given of the case where the liquid ejecting head 200 has the detection circuit 25, but the present disclosure is not limited to such an aspect. For example, the liquid ejecting apparatus 100 may have a liquid ejecting head 200 from which the detection circuit 25 is omitted, and a detection circuit 25 provided outside the liquid ejecting head 200. Specifically, the detection circuit 25 may be included in the control unit 10, for example. In the present modification example as well, the same effects as those of the embodiment and the modification examples described above can be obtained.

### 2-4. Fourth Modification Example

In the above-described embodiment, the potential of the reference voltage signal VBS supplied to the plurality of first constant voltage wirings 42 and the plurality of second constant voltage wirings 43 electrically coupled to the common electrode 52 of the piezoelectric element E may be the ground potential GND. That is, in the present modification example, the first constant voltage wiring 42 and the first analog signal wiring 44, which are held at the ground potential GND as the potential of the reference voltage signal VBS, are used to detect short circuits between the wirings of the flexible substrate 4. Therefore, in the present modification example, even when the first constant voltage wiring 42 and the first analog signal wiring 44 are short-circuited, the potential of the reference voltage signal VBS is the ground potential GND, and thus the potential of the first analog signal wiring 44 is lower than the power supply potential Vcc and the withstand voltage of the elements of the detection circuit 25. Therefore, in the present modification example, it is possible to prevent the elements of the detection circuit 25 from being destroyed when the first constant voltage wiring 42 and the first analog signal wiring 44 are short-circuited. Therefore, in the present modification example, when the liquid ejecting head 200 is refurbished, the wiring substrate 27 including the detection circuit 25 can be reused. In the present modification example as well, the same effects as those of the embodiment and the modification examples described above can be obtained.

### 2-5. Fifth Modification Example

In the above-described embodiment, an example was given of the case where the first resistance wiring 46 and the second resistance wiring 47 are provided to detect temperature changes in the pressure chamber C1, but the present disclosure is not limited to such an aspect. For example, the first resistance wiring 46 and the second resistance wiring 47 may be wirings for detecting the state of the liquid ejecting module 20, such as the temperature and humidity of the liquid ejecting module 20 other than the pressure chamber C1, the temperature and humidity in the vicinity of the liquid ejecting module 20, or the pressure within the pressure chamber C1. Alternatively, the first resistance wiring 46 and the second resistance wiring 47 may be analog signal wirings other than a wiring for detecting the state of the liquid ejecting module 20. The analog signal wiring corresponds to, for example, a wiring that transmits signals used in a circuit that operates with the power supply potential Vcc as the high power supply potential. In the present modification example as well, the same effects as those of the embodiment and the modification examples described above can be obtained.

### 2-6. Sixth Modification Example

In the above-described embodiment and modification examples, an example was given of the case where the second analog signal wiring 45 is disposed at the end portion of the flexible substrate 4 opposite the end portion at which the first analog signal wiring 44 is disposed, but the present disclosure is not limited to such an aspect. For example, the second analog signal wiring 45 may be provided at the end portion of the flexible substrate 4 on the same side as the end portion where the first analog signal wiring 44 is disposed. In this case, the first analog signal wiring 44 and the second analog signal wiring 45 only need to be disposed outside the first constant voltage wiring 42 in the direction along the Y-axis. When the dummy wiring 48 is used, it is preferable that the dummy wiring 48 and the first analog signal wiring 44 are disposed outside the second analog signal wiring 45 in the direction along the Y-axis. The dummy wiring 48 may be disposed between the first analog signal wiring 44 and the second analog signal wiring 45, or may be disposed outside the first analog signal wiring 44 in the direction along the Y-axis. Further, when the dummy wiring 48 is not used, the first analog signal wiring 44 and the second analog signal wiring 45 may be used to detect short circuits between the wirings of the flexible substrate 4. For example, when the first analog signal wiring 44 and the second analog signal wiring 45 are short-circuited, the potential Vi1 of the first analog signal wiring 44 becomes substantially the same potential as the ground potential GND, and therefore the change in the detection signal Vd behaves differently from the change in the detection signal Vd in the normal state. In the present modification example as well, the same effects as those of the embodiment and the modification examples described above can be obtained.

### 2-7. Seventh Modification Example

In the above-described embodiment and modification examples, an example was given of the case where the liquid ejecting head 200 has six liquid ejecting modules 20, but the present disclosure is not limited to such an aspect. For example, the liquid ejecting head 200 may have one or more and five or less liquid ejecting modules 20, or seven or more liquid ejecting modules 20. In the present modification example as well, the same effect as that of the embodiment described above can be obtained.

### 2-8. Eighth Modification Example

In the above-described embodiments and modification examples, the first resistance wiring 46 may be coupled to the first analog signal wiring 44 and the second analog signal wiring 45, and the second resistance wiring 47 may be coupled to an analog signal wiring different from the first analog signal wiring 44 and the second analog signal wiring 45. In the present modification example as well, the same effects as those of the embodiment and the modification examples described above can be obtained.

### 2-9. Ninth Modification Example

The liquid ejecting apparatus 100 exemplified in the above-described embodiment and modification examples can be employed in various devices such as facsimile machines and copiers, in addition to devices dedicated to printing. However, the application of the liquid ejecting apparatus according to the present disclosure is not limited to printing. For example, a liquid ejecting apparatus that ejects a solution of a coloring material is used as a manufacturing apparatus that forms a color filter of a display device such as a liquid crystal display panel. Furthermore, a liquid ejecting apparatus that ejects a solution of a conductive material is used as a manufacturing apparatus that forms wiring or an electrode of a wiring substrate. In addition, a liquid ejecting apparatus that ejects a solution of an organic material related to a living body is used as, for example, a manufacturing apparatus that manufactures a biochip. In the present modification example as well, the same effects as those of the embodiment and the modification examples described above can be obtained.

In addition, a liquid ejecting apparatus according to a fourteenth aspect, which is a preferred aspect, includes: a liquid ejecting head including an actuator substrate having a plurality of drive elements for ejecting a liquid, a wiring substrate, and a flexible substrate that electrically couples the actuator substrate and the wiring substrate; and a detection circuit, in which the flexible substrate includes a plurality of individual wirings that are arranged in a first direction and transmit a drive signal for driving each of the plurality of drive elements, a first analog signal wiring that transmits an analog signal, and a first wiring held at a first potential different from a potential of the analog signal transmitted through the first analog signal wiring, the detection circuit outputs a detection signal for detecting a state of the actuator substrate based on the analog signal transmitted via the first analog signal wiring, and the first analog signal wiring is adjacent to the first wiring and is disposed outside the plurality of individual wirings in the first direction.

According to the fourteenth aspect, the same effect as that of the first aspect can be obtained.

What is claimed is:

1. A liquid ejecting head comprising:
an actuator substrate having a plurality of drive elements for ejecting a liquid;
a wiring substrate; and
a flexible substrate that electrically couples the actuator substrate and the wiring substrate, wherein
the flexible substrate includes
a plurality of individual wirings that are arranged in a first direction and transmit a drive signal for driving each of the plurality of drive elements,
a first analog signal wiring that transmits an analog signal, and
a first wiring held at a first potential different from a potential of the analog signal transmitted through the first analog signal wiring,
the wiring substrate includes a detection circuit that outputs a detection signal for detecting a state of the actuator substrate based on the analog signal transmitted via the first analog signal wiring, and
the first analog signal wiring is adjacent to the first wiring and is disposed outside the plurality of individual wirings in the first direction.

2. The liquid ejecting head according to claim 1, wherein
the first potential is lower than the potential of the analog signal transmitted through the first analog signal wiring.

3. The liquid ejecting head according to claim 2, wherein
the first potential is a ground potential.

4. The liquid ejecting head according to claim 2, wherein
the flexible substrate includes a constant potential wiring held at a second potential as a constant potential, and
the first potential is lower than the second potential.

5. The liquid ejecting head according to claim 2, wherein
the flexible substrate includes a second analog signal wiring that transmits the analog signal,
the actuator substrate includes a relay wiring that electrically couples the first analog signal wiring and the second analog signal wiring, and
the first wiring is disposed adjacent to the first analog signal wiring and is not disposed adjacent to the second analog signal wiring.

6. The liquid ejecting head according to claim 2, wherein
the flexible substrate includes a constant potential wiring held at a second potential as a constant potential, and
the first wiring is disposed between the constant potential wiring and the first analog signal wiring in the first direction.

7. The liquid ejecting head according to claim 6, wherein
in the first direction, an interval between the first wiring and the first analog signal wiring is narrower than an interval between the first wiring and the constant potential wiring.

8. The liquid ejecting head according to claim 2, wherein
the flexible substrate includes a constant potential wiring held at a second potential as a constant potential, and
the first analog signal wiring is disposed between the constant potential wiring and the first wiring in the first direction.

9. The liquid ejecting head according to claim 8, wherein
in the first direction, an interval between the first wiring and the first analog signal wiring is narrower than an interval between the first wiring and the constant potential wiring.

10. The liquid ejecting head according to claim 3, wherein
one end of the first wiring is coupled to a terminal of the wiring substrate to which the first potential is supplied, and
another end of the first wiring is open.

11. The liquid ejecting head according to claim 2, wherein
the first wiring and the first analog signal wiring are wirings disposed at one end of a plurality of wirings provided on the flexible substrate and arranged in the first direction.

12. The liquid ejecting head according to claim 1, wherein
the first wiring is a constant potential wiring that is coupled in common to the plurality of drive elements and is held at the first potential as a constant potential.

13. A liquid ejecting apparatus comprising:
the liquid ejecting head according to claim 1; and
a determination circuit that determines a short circuit between the first wiring of the flexible substrate and the first analog signal wiring based on the detection signal.

14. A liquid ejecting apparatus comprising:
a liquid ejecting head including an actuator substrate having a plurality of drive elements for ejecting a liquid, a wiring substrate, and a flexible substrate that electrically couples the actuator substrate and the wiring substrate; and
a detection circuit, wherein
the flexible substrate includes
a plurality of individual wirings that are arranged in a first direction and transmit a drive signal for driving each of the plurality of drive elements,
a first analog signal wiring that transmits an analog signal, and
a first wiring held at a first potential different from a potential of the analog signal transmitted through the first analog signal wiring,
the detection circuit outputs a detection signal for detecting a state of the actuator substrate based on the analog signal transmitted via the first analog signal wiring, and
the first analog signal wiring is adjacent to the first wiring and is disposed outside the plurality of individual wirings in the first direction.
